(19) United States
(12) Patent Application Publication
(10) Pub. No.: US 2017/0229113 A1
(43) Pub. Date: Aug. 10, 2017

(54) ENVIRONMENTAL SOUND GENERATING APPARATUS, ENVIRONMENTAL SOUND GENERATING SYSTEM USING THE APPARATUS, ENVIRONMENTAL SOUND GENERATING PROGRAM, SOUND ENVIRONMENT FORMING METHOD AND STORAGE MEDIUM

(71) Applicant: Sangyo Kaihatsukiko Incorporation, Tokyo (JP)

(72) Inventor: Kazuhiko TOYAMA, Yokohama (JP)

(21) Appl. No.: 15/258,027

(22) Filed: Sep. 7, 2016

(30) Foreign Application Priority Data
Feb. 4, 2016 (JP) 2016-020038

(51) Int. Cl. G10L 13/033; G10L 19/012; G10L 25/51

(52) U.S. Cl. CPC G10L 13/0335; G10L 25/51; G10L 19/012; G10L 2013/021

(57) ABSTRACT

An environmental sound generating apparatus generates an environmental sound signal representing an environmental sound that forms sound environment by being emitted. The environmental sound has at least one chain of phonemes constituted of individual phonemes which sound-emission start timings as one of attributes thereof are sequentially shifted. A plurality of subgroups are prepared each formed by combining individual plural pitches from pitches constituting a primary pitch group that is a group of phonemes musically treated as consonances if sounded simultaneously. One of the plurality of subgroups selected at random is set to each of the sections of the chain of phonemes, and each of the individual phonemes of each section of the chain of phonemes is set to a pitch selected at random from the plural pitches constituting the selected subgroup to attain hypersonic effects.

### TECHNICAL FIELD

The present invention relates to an environmental sound generating apparatus for generating an environmental sound signal representing environmental sound which forms sound environment by being emitted, an environmental sound generating system using the apparatus, an environmental sound generating program, a sound environment forming method and a storage medium recording the environmental sound signal.

### BACKGROUND OF THE INVENTION

In a waiting room and a consulting room of a hospital, an office, a tearoom, and so on, in order to cancel other person's talk and noise, etc. unnecessary for remaining persons to create a quiet state and/or in order to relieve tension to bring a mentally gentle state, a reproduced sound such as BGM (background music such as healing music or classical music) or natural sound added with pink noise or the like is emitted as environmental sound (see Japanese Patent No. 3231802, for example).

As an automatic composition system used for composing pieces of music such as a test piece of music for hearing training or performance practice, Japanese Patent Publication No. 60-40027 discloses an automatic composition system which at least includes a pitch data memory which stores plural kinds of pitch data, a reading control means which randomly reads one of the plural kinds of pitch data from the pitch data memory each time a predetermined reading start signal is supplied, and a music condition discriminating means which compares the pitch data read from the pitch data memory with a predetermined musical condition. If the pitch data coincides with the predetermined musical condition, the music condition discriminating means selects this pitch data as one of constituent pitches of the piece of music. In contrast, if the pitch data does not coincide with the predetermined musical condition, the music condition discriminating means supplies the reading start signal again to the reading control means.

According to the automatic composition system disclosed in Japanese Patent Publication No. 60-40027, of the pitch data randomly read from the pitch data memory, only the pitch data coincident with the predetermined musical condition is used as one of constituent pitches of the test piece of music. Thus the random reading of one of the plural kinds of pitch data from the pitch data memory is merely one process of automatically composing a piece of music satisfying the predetermined musical condition. Further the automatic composition system disclosed in Japanese Patent Publication No. 60-40027 is used for composing a test piece of music or the like and irrelevant to environmental sound. In this manner, Japanese Patent Publication No. 60-40027 does not teach or suggest that some of the plural kinds of pitch data randomly read from the pitch data memory and arranged as it is used as environmental sound.

In a case of using BGM as environmental sound, as melodies are related to sensitivities of individual persons, it is difficult to expect the effect of BGM commonly with respect to every person. That is, as likes/dislikes and pleasantness/unpleasantness of BGM depends on individual persons, BGM is not suitable for environmental sound.

In a case of using natural sound added with pink noise or the like as environmental sound, as this sound is prepared rather faithfully based on natural sound even if pink noise or the like is added, it is also difficult to expect the effect of such the natural sound commonly for every person. Thus likes/dislikes and pleasantness/unpleasantness is divided among people depending on this natural sound. For example, as to chirping of insects in autumn evening, most Japanese people feel a sense of elegance but do not feel unpleasantness. However, the chirping of insects is mere noise for the Westerners, for example. Further some people may feel fear as to rustling of leaves by the wind. In this manner, the reproduced sound obtained by reproducing the natural sound added with pink noise or the like is also not suitable for environmental sound.

JP-A-9-81141 discloses an automatic composition system, for generating BGM, including an attribute setting means which determines a pitch corresponding to one of random integer numbers from 0 to 127, regarding note value data as to each of plural sets of note value string data of real data which is constituted of data representing sound-emission timings of plural note values and note value data representing lengths of notes. This automatic composition system further includes a means for randomly selecting the sets of note value string data of real data which is constituted of data representing sound-emission timings of plural note values, note value data and time intervals each constituted of data representing the sound-emission timing of a note value and note value data.

The automatic composition system disclosed in JP-A-9-81141 aims to generate note value strings (melodies) that is musical and felt pleasant for persons, but does not aim to generate environmental sound that can cancel other person's talk and noise, etc. unnecessary for remaining persons to create a quiet state. That is, it is impossible to cancel noise, etc. using melody data which is formed by randomly allocating pitches to tempo data based on the note value string data thus selected randomly.

JP-A-2014-219580 discloses an environmental sound generating apparatus for generating an environmental sound (EVS) signal representing environmental sound which forms sound environment by being emitted and is formed by a chain of phonemes constituted of individual phonemes that are sequentially emitted with sequentially shifted sound-emission start timings as one of the attributes thereof. This environmental sound generating apparatus includes an attribute setting means which sets at least one attribute of the individual phonemes to a content selected at random from contents within a selection item range that is set over the entirety of the chain of phonemes or at every section of the chain of phonemes.

In this case, as the at least one attribute of the individual phonemes is set to the content selected at random, the generated environmental sound may unlikely attract attention of persons. Thus when sound information to be noticed by persons is emitted simultaneously with or before/after the environmental sound, the sound information may be conspicuous from the environmental sound and listened easily. Consequently this environmental sound generating apparatus may be able to generate the environmental sound (specifically, the environmental sound signal representing environmental sound) that can, as compared with reproduced sound such as BGM or natural sound added with pink noise or the like, cancel other person's talk and noise, etc. unnecessary for remaining persons to create a quiet state and/or relieve tension to bring a mentally gentle state, without separating many people into those who likes and feel pleasure of the sound and those who do not like or feel pleasure of the sound.

### SUMMARY OF THE INVENTION

The environmental sound generating apparatus aims to constitute a digital acoustic system which suitably arranges sound environment in an object space to be filled with environmental sound to form a comfortable space.

The environmental sound is required to be emitted with a specified volume (per air capacity unit within the space) and a specified frequency band. The volume is most important because the volume is required to be almost the same at every portion within the space where the environmental sound is filled.

Further when preparing a sound space using the environmental sound, the random selection in the attribute as the most important feature of the environmental sound is required to be performed at a high level. That is, it is important to suitably reproduce different environmental sounds simultaneously from different speakers. However in the general acoustic system hitherto known, an environmental sound generated from a single sound source is distributed and generated from different speakers simultaneously. In this case, it is impossible to achieve the random selection at a high level.

In a case where a plurality of the environmental sound generating apparatuses are disposed at plural portions and the environmental sound constituted of the chain of phonemes, in which individual phonemes are formed randomly from the selected attribute, is merely generated simultaneously with the same timings from each of the environmental sound generating apparatuses, a comfortable acoustic space may not be generated to cause the following problem.

That is, a psychological silent state is required to be generated in order to form the comfortable acoustic space. To this end, it is ideal to continuously generate a sound of entire audible frequency range like noise such as white noise. However if a sound formed by randomly selected pitches is merely emitted with the same volume, such the sound is substantially same as noise and hence has an adverse effect on the improvement of sound environment in a psychological view point. This is because if the environmental sound is generated simultaneously from the plural environmental sound generating apparatuses, a merged sound of these environmental sounds likely constitutes a dissonance, thereby imparting unpleasant feeling to persons and making it impossible to suitably cancel noise.

The present invention is performed in view of the aforesaid circumstances and an object of the present invention is to provide an environmental sound generating apparatus and an environmental sound generating system using the apparatus, each of which can generate an environmental sound (specifically, an environmental sound signal representing the environmental sound) that can generate an environmental sound capable of cancelling other person's talk and noise, etc. unnecessary for remaining persons to create a quiet state and/or relieving tension to bring a mentally gentle state without separating many people into those who likes and feel pleasure of the sound and those who do not, particularly in a case of arranging a plurality of the environmental sound generating apparatuses in a large space (for example, a waiting room and a consulting room of a hospital, an office, a lecture room, a conference room, a library, a tearoom, and so on).

Another object of the present invention is to provide an environmental sound generating program for operating a computer as the environmental sound generating apparatus.

A still another object of the present invention is to provide sound environment forming method which can form sound environment capable of cancelling other person's talk and noise, etc. unnecessary for remaining persons to create a quiet state and/or relieving tension to bring a mentally gentle state without separating many people into those who likes and feel pleasure of the sound and those who do not, particularly in a case of arranging a plurality of the environmental sound generating apparatuses in a large space.

A still another object of the present invention is to provide a computer readable storage medium storing the environmental sound signal representing the environmental sound.

According to one aspect of the present invention, there is provided an environmental sound generating apparatus which generates an environmental sound signal representing an environmental sound that forms sound environment by being emitted, the environmental sound having at least one chain of phonemes constituted of individual phonemes which sound-emission start timings as one of attributes thereof are sequentially shifted, the environmental sound generating apparatus including:

an attribute setting unit which sets at least one of the attributes to a content selected at random from contents within a selection item range that is set over an entirety of the chain of phonemes or at every one of sections constituting the chain of phonemes, the at least one of the attributes including a pitch; and

a sound system which emits the environmental sound according to the environmental sound signal, wherein

a plurality of subgroups are prepared each formed by combining individual plural pitches from pitches constituting a primary pitch group that is a group of phonemes musically treated as consonances if sounded simultaneously, and wherein

the attribute setting unit sets one of the plurality of subgroups selected at random to each of the sections of the chain of phonemes, and sets each of the individual phonemes of each section of the chain of phonemes to a pitch selected at random from the plural pitches constituting the selected subgroup to attain hypersonic effects.

According to the environmental sound generating apparatus of the first aspect, the plurality of subgroups are prepared each formed by combining the individual plural pitches from the pitches constituting the primary pitch group that is the group of phonemes musically treated as consonances if sounded simultaneously. Further, one of the plurality of subgroups selected at random is set to each of the sections of the chain of phonemes, and each of the individual phonemes of each section of the chain of phonemes is set to a pitch selected at random from the plural pitches constituting the selected subgroup. The pitches constituting the primary pitch group are selected so as to constitute consonances and phonemes associated therewith. That is, the primary pitch group is a group of phonemes musically treated as consonances if sounded simultaneously (phonemes having acoustically strong consonant properties, that is, phonemes likely resonated). If all the phonemes of the primary pitch group are always sounded simultaneously from the environmental sound generating apparatus, in the physical aspect, as the generated sound covers all frequency range of noise (sound not to be listened), unnecessary sound can be canceled. Further in the psychological aspect, individual phonemes of the environmental sound generated from the environmental sound generating apparatus can be recognized as concrete pitches, volumes and lengths from infinite pitches existing in the air. Thus the environmental sound constituted of plural series of the individual phonemes away from music can be generated. Further hypersonic effects can be attained.

Thus the environmental sound generating apparatus according to this aspect can generate the environmental sound (specifically, the environmental sound signal representing the environmental sound) that can, as compared with reproduced sound such as BGM or natural sound added with pink noise or the like, cancel other person's talk and noise, etc. unnecessary for remaining persons to create a quiet state and/or relieve tension to bring a mentally gentle state, without separating many people into those who likes and feel pleasure of the sound and those who do not like or feel pleasure of the sound. Consequently as the at least one attribute (pitch in this case) of the individual phonemes is set to the content selected at random, the generated environmental sound is unlikely attract attention of persons. Thus when sound information to be noticed by persons is emitted simultaneously with or before/after the environmental sound, the sound information can be conspicuous from the environmental sound and listened easily.

According to the environmental sound generating apparatus of the second aspect, in the first aspect, the pitches of each of the plurality of subgroup are chords based on roman numeral analysis of harmony, and the pitches of the primary pitch group include at least two kinds of pitches having different pitch names and at least one kind of pitch which has a different octave but has the same pitch name with respect to at least one of the at least two kinds of pitches.

According to the environmental sound generating apparatus of the third aspect, in the second aspect, the environmental sound is constituted of a plurality of the chains of phonemes, and wherein the attribute setting unit commonly sets the selected subgroup to all of temporally corresponding sections of the plurality of chains of phonemes, and sets each of the individual phonemes of each of the temporally corresponding sections of the plurality of chains of phonemes to a pitch selected at random from the plural pitches constituting the commonly set subgroup.

According to the environmental sound generating apparatus of the fourth aspect, in the third aspect, the attribute setting unit sets a time period from start to termination of sound emission of each of the individual phonemes to constant, and sets sound-emission start timings of the temporally corresponding sections of the plurality of chains of phonemes so as to be shifted sequentially.

According to the fifth aspect of the present invention, there is provided an environmental sound generating system, including:

a plurality of environmental sound generating apparatuses arranged in an object space dispersively, each of the plurality of environmental sound generating apparatuses generating an environmental sound signal representing an environmental sound that forms sound environment by being emitted, the environmental sound having at least one chain of phonemes constituted of individual phonemes which sound-emission start timings as one of attributes thereof are sequentially shifted, wherein

each of the plurality of environmental sound generating apparatuses including:

an attribute setting unit which sets at least one of the attributes to a content selected at random from contents within a selection item range that is set over an entirety of the chain of phonemes or at every one of sections constituting the chain of phonemes, the at least one of the attributes including a pitch; and

a sound system which emits the environmental sound according to the environmental sound signal, wherein

a plurality of subgroups are prepared each formed by combining individual plural pitches from pitches constituting a primary pitch group that is a group of phonemes musically treated as consonances if sounded simultaneously, and wherein

the attribute setting unit sets one of the plurality of subgroups selected at random to each of the sections of the chain of phonemes, and sets each of the individual phonemes of each section of the chain of phonemes to a pitch selected at random from the plural pitches constituting the selected subgroup to attain hypersonic effects.

According to the environmental sound generating system of the fifth aspect, in the object space surrounded by the plural EVS generating apparatuses, the environmental sounds of different subgroups are basically always generated simultaneously and transmitted to listeners from different directions. Thus as the randomness of the pitches, etc., can be enhanced as compared with a case of listening the environmental sound generated from the single EVS generating apparatus, a degree of noticing the sound can be reduced, and hence the environmental sounds cannot be listened or recognized as noise for listeners, thereby not imparting unpleasant feeling to the listeners. This effect can be enhanced by increasing the number of the chains of phonemes (tracks) in each of the EVS generating apparatuses.

Further the more the number of the EVS generating apparatus to be disposed in the object space, the more directivity or directionality of the listeners with respect to the environmental sound can be weakened, and hence a state closer to a psychological silent state for the listeners can be formed. This is because if all the phonemes of the primary pitch group are listened simultaneously from a single EVS generating apparatus, this soundmay be recognized as a dissonance, whilst all the phonemes of the primary pitch group sounded simultaneously from plural (e.g., three) directions are unlikely or hardly recognized as a dissonance. Consequently, the EVS generating apparatuses arranged in the aforesaid manner can generate the environmental sound that can cancel other person's talk and noise, etc. unnecessary for remaining persons to create a quiet state and/or relieve tension tobringamentally gentle state, without separating many people into those who likes and feel pleasure of the sound and those who do not like or feel pleasure of the sound.

According to the environmental sound generating system of the sixth aspect, in the fifth aspect, in each of the plurality of environmental sound generating apparatuses, the pitches of each of the plurality of subgroup are chords based on the roman numeral analysis of harmony, and the pitches of the primary pitch group include at least two kinds of pitches having different pitch names and at least one kind of pitch which has a different octave but has the same pitch name with respect to at least one of the at least two kinds of pitches.

According to the environmental sound generating system of the seventh aspect, in the sixth aspect, in each of the plurality of environmental sound generating apparatuses, the environmental sound is constituted of a plurality of the chains of phonemes, and wherein the attribute setting unit commonly sets the selected subgroup to all of temporally corresponding sections of the plurality of chains of phonemes, and sets each of the individual phonemes of each of the temporally corresponding sections of the plurality of chains of phonemes to a pitch selected at random from the plural pitches constituting the commonly set subgroup.

According to the environmental sound generating system of the eighth aspect, in the seventh aspect, in each of the plurality of environmental soundgenerating apparatuses, the attribute setting unit sets a time period from start to termination of sound emission of each of the individual phonemes to constant, and sets sound-emission start timings of the temporally corresponding sections of the plurality of chains of phonemes so as to be shifted sequentially.

According to the ninth aspect of the present invention, there is provided an environmental sound generating system, including:

a plurality of environmental sound generating apparatuses arranged in an object space dispersively, each of the plurality of environmental sound generating apparatuses generating an environmental sound signal representing an environmental sound that forms sound environment by being emitted, the environmental sound having at least one chain of phonemes constituted of individual phonemes which sound-emission start timings as one of attributes thereof are sequentially shifted, and

a controller which controls the plurality of environmental sound generating apparatuses, wherein

each of the plurality of environmental sound generating apparatuses including:

an attribute setting unit which sets at least one of the attributes to a content selected at random from contents within a selection item range that is set over an entirety of the chain of phonemes or at every one of sections constituting the chain of phonemes, the at least one of the attributes including a pitch; and

a sound system which emits the environmental sound according to the environmental sound signal, wherein

a plurality of subgroups are prepared each formed by combining individual plural pitches from pitches constituting a primary pitch group that is a group of phonemes musically treated as consonances if sounded simultaneously, and wherein

the attribute setting unit sets one of the plurality of subgroups selected at random to each of the sections of the chain of phonemes, and sets each of the individual phonemes of each section of the chain of phonemes to a pitch selected at random from the plural pitches constituting the selected subgroup to attain hypersonic effects.

According to the environmental sound generating system of the ninth aspect, as each of the environmental sound generating apparatuses can be controlled by the controller, more suitable environmental sound can be generated.

According to the environmental sound generating system of the tenth aspect, in the ninth aspect, each of the plurality of environmental sound generating apparatuses includes an environmental information acquisition unit which acquires environmental information of an object space corresponding to the environmental sound generating apparatus and transmits acquired environmental information to the controller, and wherein

the controller receives the acquired environmental information from the plurality of environmental sound generating apparatuses, then generates a control signal for controlling the individual environmental sounds emitted from the plurality of environmental sound generating apparatuses based on the received environmental information and transmits the control signal to the plurality of environmental sound generating apparatuses.

According to the environmental sound generating system of the tenth aspect, as the environmental sound generated from each of the environmental sound generating apparatuses can be controlled by the controller based on the environmental information of the object space corresponding to the environmental sound generating apparatus, more suitable environmental sound can be generated.

According to the environmental sound generating system of the eleventh aspect, in the ninth aspect, the environmental information acquisition unit of each of the plurality of environmental sound generating apparatuses includes an imaging unit which obtains an image of the corresponding object space and outputs an image detection signal and a sound detection unit which detects sound of the corresponding object space and outputs a sound detection signal,

the environmental information acquisition unit transmits the image detection signal and the sound detection signal to the controller as the environmental information, and wherein

the controller receives the acquired environmental information from the plurality of environmental sound generating apparatuses, then generates a control signal for controlling at least one of volume level, phase and tone quality of the individual environmental sounds emitted from the plurality of environmental sound generating apparatuses based on the received environmental information and transmits the control signal to the plurality of environmental sound generating apparatuses.

According to the environmental sound generating system of the eleventh aspect, as the volume level, phase and tone quality of the individual environmental sound emitted from each of the plurality of environmental sound generating apparatuses can be controlled by the controller based on the image and the sound of the corresponding object space as the environmental information of the object space, more suitable environmental sound can be generated.

According to the twelfth aspect of the present invention, there is provided a computer program executable by a computer, for use in an environmental sound generating apparatus which generates an environmental sound signal representing an environmental sound that forms sound environment by being emitted, the environmental sound having at least one chain of phonemes constituted of individual phonemes which sound-emission start timings as one of attributes thereof are sequentially shifted, the program comprising the steps of:

setting at least one of the attributes to a content selected at random from contents within a selection item range that is set over an entirety of the chain of phonemes or at every one of sections constituting the chain of phonemes, the at least one of the attributes including a pitch;

preparing a plurality of subgroups each formed by combining individual plural pitches from pitches constituting a primary pitch group that is a group of phonemes musically treated as consonances if sounded simultaneously; and

setting one of the plurality of subgroups selected at random to each of the sections of the chain of phonemes, and setting each of the individual phonemes of each section of the chain of phonemes to a pitch selected at random from the plural pitches constituting the selected subgroup to attain hypersonic effects.

According to the thirteenth aspect of the present invention, there is provided a sound environment forming method of forming sound environment by emitting an environmental sound constituted of a plurality of chains of phonemes each of which is constituted of individual phonemes which sound-emission start timings as one of attributes thereof are sequentially shifted, comprising the steps of:

as to at least one of the plurality of chains of phonemes, setting at least one of the attributes to a content selected at random from contents within a selection item range that is set over an entirety of the chain of phonemes or at every one of sections constituting the chain of phonemes, the at least one of the attributes including a pitch;

preparing a plurality of subgroups each formed by combining individual plural pitches from pitches constituting a primary pitch group that is a group of phonemes musically treated as consonances if sounded simultaneously; and

setting one of the plurality of subgroups selected at random to each of the sections of the chain of phonemes, and setting each of the individual phonemes of each section of the chain of phonemes to a pitch selected at random from the plural pitches constituting the selected subgroup to attain hypersonic effects.

According to the sound environment forming method of the thirteenth aspect, the effects similar to that of the first aspect can be achieved.

According to the sound environment forming method of the fourteenth aspect, in the thirteenth aspect, the pitches of each of the plurality of subgroup are chords based on the roman numeral analysis of harmony, and the pitches of the primary pitch group include at least two kinds of pitches having different pitch names and at least one kind of pitch which has a different octave but has the same pitch name with respect to at least one of the at least two kinds of pitches.

According to the sound environment forming method of the fifteenth aspect, in the fourteenth aspect, the environmental sound is constituted of a plurality of the chains of phonemes, and wherein the selected subgroup are commonly set to all of temporally corresponding sections of the plurality of chains of phonemes, and each of the individual phonemes of each of the temporally corresponding sections of the plurality of chains of phonemes is set to a pitch selected at random from the plural pitches constituting the commonly set subgroup.

According to the sound environment forming method of the sixteenth aspect, in the fifteenth aspect, a time period from start to termination of sound emission of each of the individual phonemes is to constant, and sound-emission start timings of the temporally corresponding sections of the plurality of chains of phonemes are set so as to be shifted sequentially.

According to the seventeenth aspect of the present invention, there is provided a storage medium storing program executed by a computer, for use in an environmental sound generating apparatus which generates an environmental sound signal representing an environmental sound that forms sound environment by being emitted, the environmental sound having at least one chain of phonemes constituted of individual phonemes which sound-emission start timings as one of attributes thereof are sequentially shifted, the program comprising the steps of:

setting at least one of the attributes to a content selected at random from contents within a selection item range that is set over an entirety of the chain of phonemes or at every one of sections constituting the chain of phonemes, the at least one of the attributes including a pitch;

preparing a plurality of subgroups each formed by combining individual plural pitches from pitches constituting a primary pitch group that is a group of phonemes musically treated as consonances if sounded simultaneously; and

setting one of the plurality of subgroups selected at random to each of the sections of the chain of phonemes, and setting each of the individual phonemes of each section of the chain of phonemes to a pitch selected at random from the plural pitches constituting the selected subgroup to attain hypersonic effects.

The present invention can provide the environmental sound generating apparatus and the environmental sound generating system each of which can generate the environmental sound (specifically, the environmental sound signal representing the environmental sound) that can, as compared with reproduced sound such as BGM or natural sound added with pink noise or the like, cancel other person's talk and noise, etc. unnecessary for remaining persons to create a quiet state and/or relieve tension to bring a mentally gentle state in a large object space, without separating many people into those who likes and feel pleasure of the sound and those who do not like or feel pleasure of the sound.

Further the present invention can provide the environmental sound generating program for acting a computer as such the environmental sound generating apparatus.

Further the present invention can provide the sound environment forming method which forms the sound environment that can cancel other person's talk and noise, etc. unnecessary for remaining persons to create a quiet state and/or relieve tension to bring a mentally gentle state in a large object space, without separating many people into those who likes and feel pleasure of the sound and those who do not like or feel pleasure of the sound.

Further the present invention can provide the storage medium which records the program for generating the environmental sound or the storage medium which records the environmental sound signal representing the environmental sound.

### BRIEF DESCRIPTION OF THE DRAWINGS

FIG. 1 is a conceptional diagram illustrating a concrete example of a primary pitch group and subgroups thereof;

FIG. 2 is a schematic diagram illustrating an example of phonemes of the primary pitch group;

FIG. 3A shows an example of an environmental sound in a case of merging environmental sounds generated from four environmental sound generating apparatuses;

FIGS. 3B to 3E show individual examples of four environmental sounds, each constituted of four chains of phonemes (four tracks), emitted from the four environmental sound generating apparatuses, respectively;

FIG. 4 is a schematic block diagram illustrating an environmental sound generating apparatus according to a first embodiment of the present invention;

FIG. 5 is a timing chart schematically illustrating an example of note-on periods of four tracks which represents an environmental sound generated by the environmental sound generating apparatus shown in FIG. 4;

FIG. 6 is a schematic flowchart showing an example of an operation of the environmental sound generating apparatus shown in FIG. 4;

FIG. 7 is a schematic flowchart illustrating an operation of step S4 of FIG. 6;

FIG. 8 is a conceptual diagram illustrating an example of an environmental sound constituted of four tracks which represents an environmental sound generated by the environmental sound generating apparatus according to the first embodiment;

FIG. 9 is a schematic block diagram illustrating an environmental sound generating system according to a second embodiment of the present invention;

FIG. 10 shows an example of environmental sounds generated by four environmental sound generating apparatuses in the environmental sound generating system according to the second embodiment;

FIG. 11 is a schematic block diagram illustrating an environmental sound generating system according to a third embodiment of the present invention;

FIG. 12A is a schematic block diagram illustrating an example of an environmental sound generating apparatus in FIG. 11;

FIG. 12B is a schematic block diagram illustrating an example of a satellite device in FIG. 11;

FIG. 13 is a schematic diagram illustrating a layout in an object space for performing an experiment so as to verify the effects of the environmental sound generating apparatus according to the first to third embodiments;

FIG. 14 is a diagram showing typical measurement results of frequency characteristics in a case of emitting a typical classical music played by a piano;

FIG. 15 shows one example of typical measurement results of frequency characteristics of the environmental sound generated from the environmental sound generating apparatus according to the second or third embodiment;

FIG. 16 shows another example of typical measurement results of frequency characteristics of the environmental sound generated from the environmental sound generating apparatus according to the second or third embodiment;

FIG. 17 shows an example of typical measurement results of frequency characteristics of the environmental sound generated from the environmental sound generating apparatus according to the second or third embodiment and an example of typical measurement results of frequency characteristics of noise, in a usual room such as an office or a conference room;

FIG. 18 shows another example of typical measurement results of frequency characteristics of the environmental sound generated from the environmental sound generating apparatus according to the second or third embodiment and another example of typical measurement results of frequency characteristics of noise, in a usual room such as an office or a conference room;

FIG. 19 shows an example of typical measurement results of frequency characteristics of the environmental sound generated using the single environmental sound generating apparatus according to the second or third embodiment;

FIG. 20 shows an example of typical measurement results of frequency characteristics of the environmental sound generated using the three environmental sound generating apparatuses according to the second or third embodiment;

FIG. 21 is a schematic block diagram illustrating an environmental sound generating system according to a fourth embodiment of the present invention;

FIG. 22A is a schematic block diagram illustrating an example a controller according to the fourth embodiment;

FIG. 22B is a schematic block diagram illustrating an example an environmental sound generating apparatus (satellite device) according to the fourth embodiment;

FIG. 23 is a schematic diagram illustrating an example of the arrangement of microphones and cameras in the environmental sound generating system according to the fourth embodiment; and

FIG. 24 is a schematic flowchart showing an example of an operation of the environmental sound generating system according to the fourth embodiment.

### DETAILED DESCRIPTION OF EMBODIMENTS

Hereinafter an environmental sound (EVS) generating apparatus, an environmental sound generating system, an environmental sound generating program, a sound environment forming method and a storage medium according to embodiments of the present invention will be explained with reference to accompanying drawings.

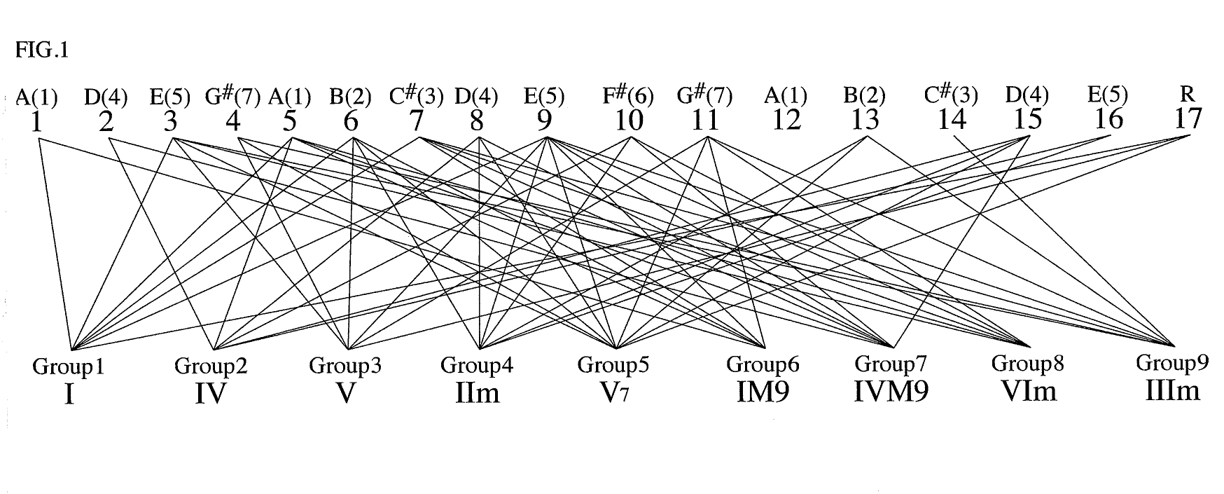

Prior to the explanation of the embodiments, technical concept of the invention will be explained with reference to FIGS. 1 to 3.

The environmental sound generating apparatus etc. according to the embodiments of the invention is intended to produce a psychological silent state. To this end, it is ideal to continuously generate a sound of entire audible frequency range like noise such as white noise. However, in general, as noise is unpleasant for person, the invention uses musical idea.

Further, in general, sound is formed by mixture of a sound wave (keynote) having a large amplitude (large volume level) and sound waves (harmonics) having quite small amplitudes generated based on the keynote. By emitting plural sound waves (tone colors) each containing many harmonics simultaneously, the air can be vibrated over a quite large frequency range. According to the EVS of the invention, tone colors and pitches easily resonating the air are selectively produced. If phonemes composed of randomly selected pitches are emitted randomly from a plurality of environmental sound generating apparatuses with the same volume, the generated sound is substantially same as noise. Such the sound has an adverse effect on a psychological aspect of suitably arranging sound environment.

In view of this, according to the invention, a plurality of pitches are selected as a primary pitch group (tonality or key in music theory), and plural subgroups are prepared each by suitably extracting individual plural pitches from the primary pitch group. The environmental sound generating apparatus sequentially generates phonemes of the pitches of single subgroup randomly selected from the plural subgroups, as a chain of phonemes. Each of the other environmental sound generating apparatuses also sequentially generates phonemes of the pitches of the selected subgroup as a chain of phonemes.

The pitches constituting the primary pitch group are selected so as to constitute consonances and phonemes associated therewith. That is, the primary pitch group is a group of phonemes musically treated as consonances if sounded simultaneously (phonemes having acoustically strong consonant properties, that is, phonemes likely resonated). The subgroups are prepared each by suitably combining individual plural pitches from the pitches constituting the primary pitch group. The pitches constituting the primary pitch group satisfy a predetermined musical condition, that is, tonality. Even if the subgroups simultaneously sounded from the different environmental sound generating apparatuses differ to each other, as the pitches of these subgroups belong to the same tonality, listeners hardly feel unpleasantness. In order to prevent, if at all possible, listeners being tired of listening such the sound and trying to consciously confirm the sound, the plurality of subgroups are prepared. To this end, in each of the environmental sound generating apparatuses, preferably, shifting from one of the subgroups to another subgroup is performed sequentially with a given interval. Even in this case, as the subgroup after the shifting is selected from the subgroups of the primary pitch group, abrupt change of sound impression can be suppressed between the subgroups before and after the shifting.

According to the EVS theory of the invention, a plurality of phonemes having a large degree of resonance are extracted as the primary pitch group from the natural (integer order) harmonic overtone series based on the music theory, and the phonemes of this group are selectively sounded simultaneously to effectively vibrate or resonate the air.

According to the EVS theory of the invention, although a sound of a quite large frequency range such as pink noise is secured by simultaneously emitting plural chains of phonemes each constituted of individual phonemes, as the phonemes simultaneously sounded belong to the primary pitch group, a state similar to the tonality music based on the music theory can be created. Further, the EVS according to the invention can create sound environment which can eliminate, as much as possible, melody element mostly causing listeners to make notice the sound as music but can gently cause listeners to notice a time lapse.

Although the conventional environmental sound generating apparatus generates a sound covering a large frequency range but cannot cause listeners to make notice the sound as music or the like.

There is physical aspect and psychological aspect as a method of realizing a sound not to be noticed by listeners, aimed by the EVS theory of the invention. The point of the physical aspect is to control a volume, quality and a direction of the sounds by a plurality of the environmental sound generating apparatuses. The point of the psychological aspect is to form the subgroups each constituted by individual pitches selected based on understanding of musical expression, plural chains of phonemes selected based on the music theory, and emission timings and relative volumes of the phonemes.

The music theory is an empirical rule systemized to create good music and music is composed so as to cause a listener to make notice a sound as music based on the listener's memory. In this case, it is effective, firstly, to create a series of phonemes to be listened conspicuously as melody and, secondarily, to create consciously repetition or regularity of phonemes as a melody so as to easily cause listeners to notice feeling of a time lapse.

According to the EVS theory of the invention, a sound is generated under a condition that, if at all possible, these two points are eliminated at the time of automatically creating the sound. The sound generated from the phonemes of the subgroups is a synthetic sound containing many harmonic components so as to prevent listeners remembering or thinking of a particular musical instrument. In preparing each of the subgroups, a phoneme to be substantially the center or main of the primary pitch group is set based on the music theory. The, chains of phonemes each constituted of the subgroup similar to the tonality music are emitted in a manner of sequentially changing or shifting the subgroups. The chain of phonemes is prepared based on the tonality music because the setting of the center or main phoneme contributes to mental stability for listeners. Further the sequential changing or shifting of the subgroups is performed based on the harmony theory of the traditional music theory.

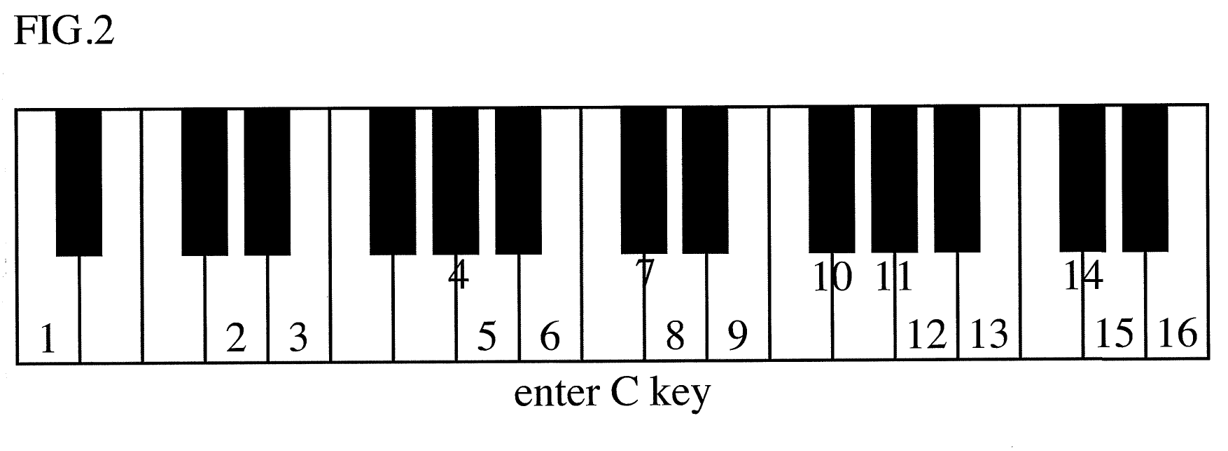

FIG. 1 is a conceptional diagram illustrating a concrete example of the primary pitch group and the subgroups thereof. FIG. 2 is a schematic diagram illustrating an example of phonemes of the primary pitch group on keys of a keyboard instrument such as a piano.

As a typical example, the primary pitch group is a major scale constituted by including a keynote (tonic or tonal center) of about 440 Hz (in general, A4). The primary pitch group ranges from the lowest sound of A2 to the highest sound of E5 (about 660 Hz). That is, the primary pitch group has the range of two and a half octaves. According to the Western music theory, 32 phonemes are contained in the two and a half octaves. Of these 32 phonemes, phonemes contained as A major and likely resonated are extracted as the primary pitch group.

Specifically, the phonemes of the primary pitch group are A(1), D(4), E(5), G#(7), A(1), B(2), C#(3), D(4), E(5), F#(6), G#(7), A(1), B(2), C#(3), D(4), E(5) which correspond to Nos. 1 to 16 denoted on the keys in FIG. 2, respectively. R (rest) denoted by the No. 17 represents silent.

Based on the harmonic theory of the Western music, for example, nine subgroups SG1 (I), SG2 (IV), SG3 (V), SG4 (IIm), SG5 (V7), SG6 (IM9), SG7 (IVM9), SG8 (VIm) and SG9 (IIIm) shown in FIG. 1 are prepared from the phonemes of the primary pitch group. The symbols within the parentheses represent chord names based on the roman numeral analysis of harmony.

For example, A major is constituted of seven phonemes, i.e., A, B, C#, D, E, F# and G#. Each of the subgroups is prepared by suitably selecting the phonemes likely resonated, using one of A, B and F of these seven phonemes as a root. Although only three kinds of subgroups are prepared in a case of using these phonemes, listener's impression upon sounding the phonemes of the subgroup largely differs depending on the phoneme selected as the lowest phoneme.

That is, for example, as to the subgroup constituted of A, C# and E, listener's impression upon sounding the phonemes of the subgroup differs between a case of selecting A as the lowest phoneme and a case of selecting C# and E as the lowest phoneme. Further the subgroups are prepared in view of the combination of the phonemes belonging to the higher range.

The phoneme denoted by “1” in FIG. 2 has a reference frequency of 110Hz and is allowed to be ranged from 98.0 to 123.5 Hz. Similarly the phoneme denoted by “2” in FIG. 2 has a reference frequency of 146.81 Hz and is allowed to be ranged from 130.8 to 164.8 Hz. The phoneme denoted by “3” in FIG. 2 has a reference frequency of 165 Hz and is allowed to be ranged from 146.8 to 185.0 Hz. The phoneme denoted by “4” in FIG. 2 has a reference frequency of 207.7 Hz and is allowed to be ranged from 185 to 233.1 Hz. The phoneme denoted by “5” in FIG. 2 has a reference frequency of 220 Hz and is allowed to be ranged from 196 to 246.9 Hz. The phoneme denoted by “6” in FIG. 2 has a reference frequency of 246.9 Hz and is allowed to be ranged from 196 to 277.2 Hz. The phoneme denoted by “7” in FIG. 2 has a reference frequency of 277.2 Hz and is allowed to be ranged from 246.9 to 311.1 Hz. The phoneme denoted by “8” in FIG. 2 has a reference frequency of 293.7 Hz and is allowed to be ranged from 261.6 to 330 Hz. The phoneme denoted by “9” in FIG. 2 has a reference frequency of 330 Hz and is allowed to be ranged from 293.7 to 370 Hz. The phoneme denoted by “10” in FIG. 2 has a reference frequency of 370 Hz and is allowed to be ranged from 330 to 415.3 Hz. The phoneme denoted by “11” in FIG. 2 has a reference frequency of 415.3 Hz and is allowed to be ranged from 370 to 466.2 Hz. The phoneme denoted by “12” in FIG. 2 has a reference frequency of 440 Hz and is allowed to be ranged from 392 to 494 Hz. The phoneme denotedby “13” in FIG. 2 has a reference frequency of 494 Hz and is allowed to be ranged from 440 to 554.4 Hz. The phoneme denoted by “14” in FIG. 2 has a reference frequency of 554.4 Hz and is allowed to be ranged from 494 to 622.3 Hz. The phoneme denoted by “15” in FIG. 2 has a reference frequency of 587.3 z and is allowed to be ranged from 523.3 to 659.3 Hz. The phoneme denoted by “16” in FIG. 2 has a reference frequency of 659.3 z and is allowed to be ranged from 587.3 to 740 Hz.

In an example of the environmental sound generating apparatus according to invention, there is provided the environmental sound generating apparatus which generates an environmental sound signal representing an environmental sound that forms sound environment by being emitted, the environmental sound having at least one chain of phonemes constituted of individual phonemes which sound-emission start timings as one of attributes thereof are sequentially shifted, the environmental sound generating apparatus including:

an attribute setting unit which sets at least one of the attributes to a content selected at random from contents within a selection item range that is set over an entirety of the chain of phonemes or at every one of sections constituting the chain of phonemes, the at least one of the attributes including a pitch; and

a sound system which emits the environmental sound according to the environmental sound signal, wherein

a plurality of subgroups are prepared each formed by combining individual plural pitches from pitches constituting a primary pitch group that is a group of phonemes musically treated as consonances if sounded simultaneously, and wherein

the attribute setting unit sets one of the plurality of subgroups selected at random to each of the sections of the chain of phonemes, and sets each of the individual phonemes of each section of the chain of phonemes to a pitch selected at random from the plural pitches constituting the selected subgroup to attain hypersonic effects.

In an example of the environmental sound generating system according to invention, there is provided the environmental sound generating system, including:

a plurality of environmental sound generating apparatuses arranged in an object space dispersively, each of the plurality of environmental sound generating apparatuses generating an environmental sound signal representing an environmental sound that forms sound environment by being emitted, the environmental sound having at least one chain of phonemes constituted of individual phonemes which sound-emission start timings as one of attributes thereof are sequentially shifted, wherein

each of the plurality of environmental sound generating apparatuses including:

an attribute setting unit which sets at least one of the attributes to a content selected at random from contents within a selection item range that is set over an entirety of the chain of phonemes or at every one of sections constituting the chain of phonemes, the at least one of the attributes including a pitch; and

a sound system which emits the environmental sound according to the environmental sound signal, wherein

a plurality of subgroups are prepared each formed by combining individual plural pitches from pitches constituting a primary pitch group that is a group of phonemes musically treated as consonances if sounded simultaneously, and wherein

the attribute setting unit sets one of the plurality of subgroups selected at random to each of the sections of the chain of phonemes, and sets each of the individual phonemes of each section of the chain of phonemes to a pitch selected at random from the plural pitches constituting the selected subgroup to attain hypersonic effects.

Preferably, in each of the plurality of environmental sound generating apparatuses, the pitches of each of the plurality of subgroup are chords based on the roman numeral analysis of harmony, and the pitches of the primary pitch group include at least two kinds of pitches having different pitch names and at least one kind of pitch which has a different octave but has the same pitch name with respect to at least one of the at least two kinds of pitches.

Preferably, in each of the plurality of environmental sound generating apparatuses, the environmental sound is constituted of a plurality of the chains of phonemes, and wherein the attribute setting unit commonly sets the selected subgroup to all of temporally corresponding sections of the plurality of chains of phonemes, and sets each of the individual phonemes of each of the temporally corresponding sections of the plurality of chains of phonemes to a pitch selected at random from the plural pitches constituting the commonly set subgroup.

Preferably, in each of the plurality of environmental sound generating apparatuses, the attribute setting unit sets a time period from start to termination of sound emission of each of the individual phonemes to constant, and sets sound-emission start timings of the temporally corresponding sections of the plurality of chains of phonemes so as to be shifted sequentially.

Preferably, in each of the plurality of environmental sound generating apparatuses, the environmental sound attains the hypersonic effects in a frequency range of substantially 50,000 to 80,000 Hz.

According to this configuration, in an object space surrounded by a plurality of the environmental sound generating apparatuses, the phonemes of the different subgroups are basically generated always from these apparatuses and plural sounds are listened in a merged manner from the plural directions. For example, in a case of providing a plurality of (e.g., four) environmental sound generating apparatuses each emitting a plurality of (e.g., three (three tracks)) chains of phonemes, all the phonemes of the primary pitch group may be listened simultaneously at some moment. If all the phonemes of the primary pitch group are listened simultaneously from a single environmental sound generating apparatus, this sound may be recognized as a dissonance, whilst all the phonemes of the primary pitch group sounded simultaneously from plural (e.g., four) directions are unlikely or hardly recognized as a dissonance. This is because when the phonemes of different subgroups are transmitted simultaneously toward listeners from different directions, randomness of the pitches, etc., is enhanced and a degree of noticing the sound can be reduced for the listeners as compared with the case of emitting the phonemes of different subgroups simultaneously toward the listeners from one direction (i.e., one environmental sound generating apparatus). Thus the environmental sounds transmitted from the plural directions cannot be listened or recognized as noise for listeners, thereby not imparting unpleasant feeling to the listeners. Such the effects can be enhanced by increasing the number of the chains of phonemes (tracks). Further, the more the number of the environmental sound generating apparatus to be disposed in the object space, the more directivity or directionality of the listeners with respect to the environmental sound can be weakened, and hence a state closer to a psychological silent state for the listeners can be formed. Consequently, the environmental sound generating apparatuses arranged in the aforesaid manner can generate the environmental sound (specifically, the environmental sound signal representing environmental sound) that can, as compared with reproduced sound such as BGM or natural sound added with pink noise or the like, cancel other person's talk and noise, etc. unnecessary for remaining persons to create a quiet state and/or relieve tension to bring a mentally gentle state, without separating many people into those who likes and feel pleasure of the sound and those who do not like or feel pleasure of the sound.

This feature will be explained more in detail. If all the phonemes of the primary pitch group are always sounded simultaneously from the environmental sound generating apparatus, in the physical aspect, as the generated sound covers all frequency range of noise (sound not to be listened), unnecessary sound can be canceled. Further in the psychological aspect, individual phonemes of the environmental sound generated from the environmental sound generating apparatus can be recognized as concrete pitches, volumes and lengths from infinite pitches existing in the air, which releases listeners from uneasy feeling that the generated sound is incomprehensible.

On the other hand, as the state where all the phonemes of the primary pitch group are always sounded simultaneously is close to a state existing within the noise, it seems to be difficult to completely release listeners from the uneasy feeling.

In view of this, when the phonemes of different subgroups, which are selected from all the subgroups constituted of phonemes primarily selected based on acoustics and the music theory, are sounded simultaneously, a resonant state may be created. However, as it may be impossible to simultaneously sound all the phonemes of the primary pitch group, it seems to be preferable to compensate the phonemes not selected by the subgroups to be sounded. Thus, by using at least two environmental sound generating apparatuses, the subgroup (or subgroups) containing the phonemes not sounded from the one environmental sound generating apparatus is possibly generated from the remaining environmental sound generating apparatus (or apparatuses).

However, as described above, as the state where all the phonemes of the primary pitch group are always sounded simultaneously is close to a state existing within the noise, it seems to be difficult to completely release listeners from the uneasy feeling. In this respect, the inventors of the invention paid attention to that each people has directivity or directionality as to recognition of a sound (that is, each people has an ability of distinguishably recognize sounds transmitted from different directions), and then thought of arranging a plurality of the environmental sound generating apparatuses at different positions. By doing so, basically as the phonemes of the different subgroups (that is, environmental sound creating resonant sound) are emitted from the different directions from a plurality of sound sources (environmental sound generating apparatuses), a state where substantially all the phonemes of the primary pitch group are emitted can be created. Recognizing directivity or directionality of a sound by a listener is considered to mean noticing the sound by the listener. The directivity or directionality (noticing) of the listeners with respect to the environmental sound can be weakened by arranging a plurality of (e.g., three or more) the environmental sound generating apparatuses.

As a result, although almost all the phonemes of the primary pitch group are emitted in the object space, it is possible to create a state or space in which listeners can almost unconsciously recognize that sounds less in uneasy feeling for the listeners are listened from various directions.

According to another mode of the invention, a plurality of the environmental sound generating apparatuses are arranged in the object space, and a control center (controller) for totally controlling these apparatuses (volume control , etc.) based on environmental information within the object space is added, whereby an environmental sound space more closer to an ideal state can be created.

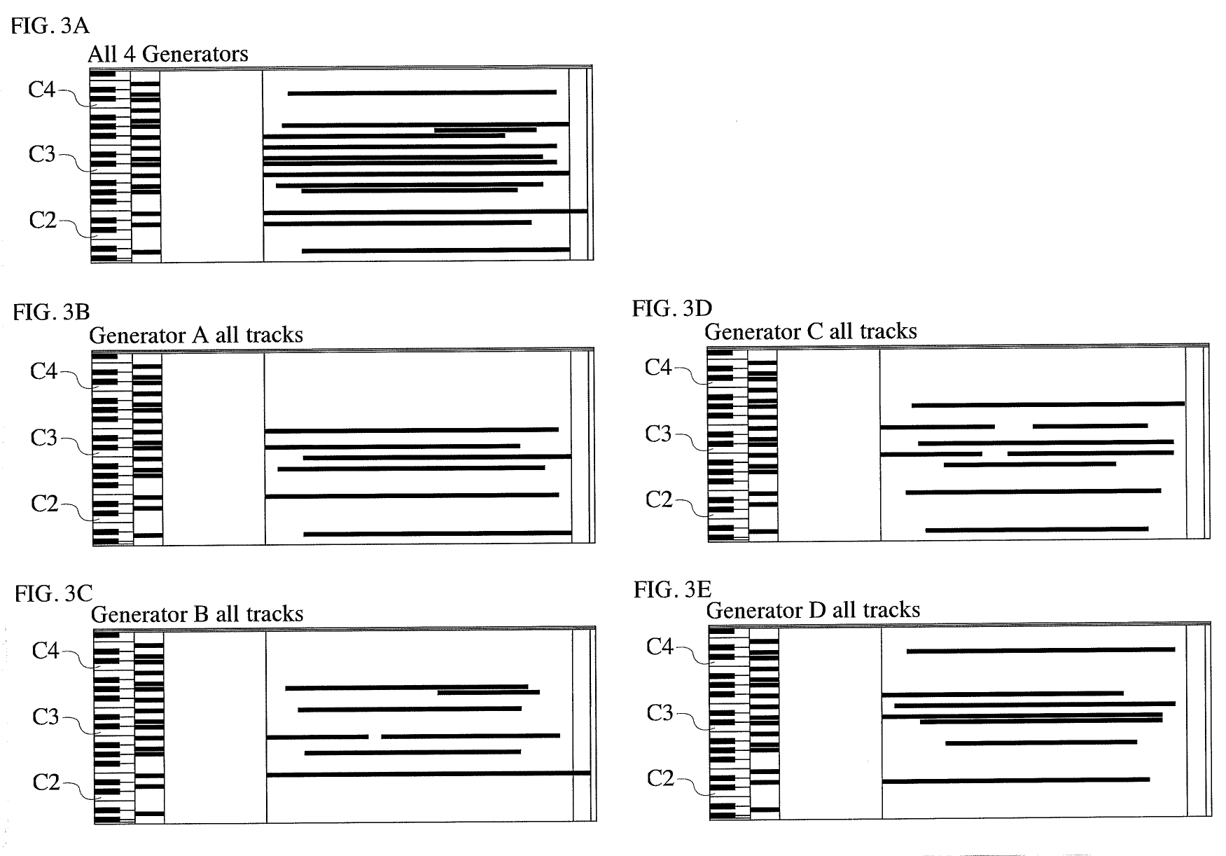

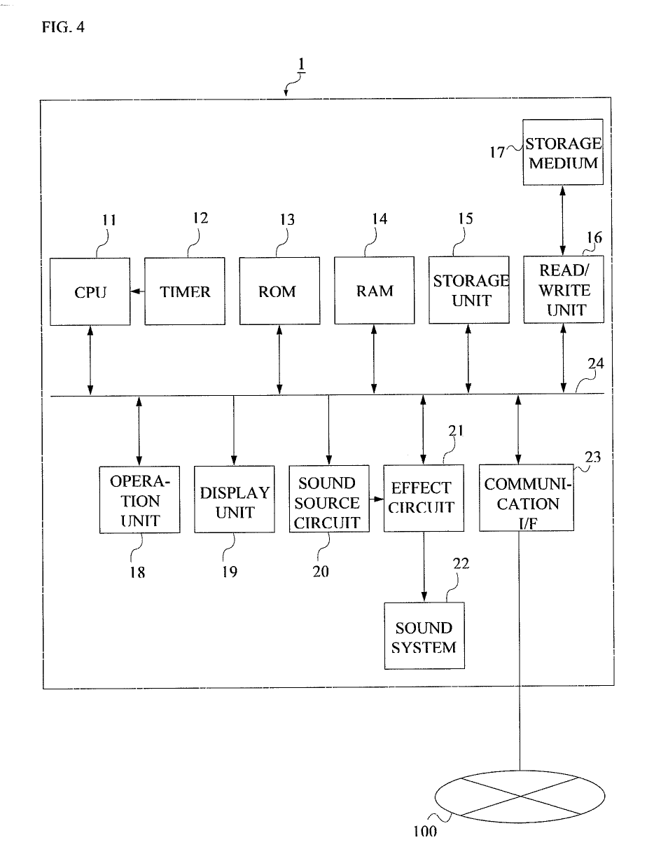

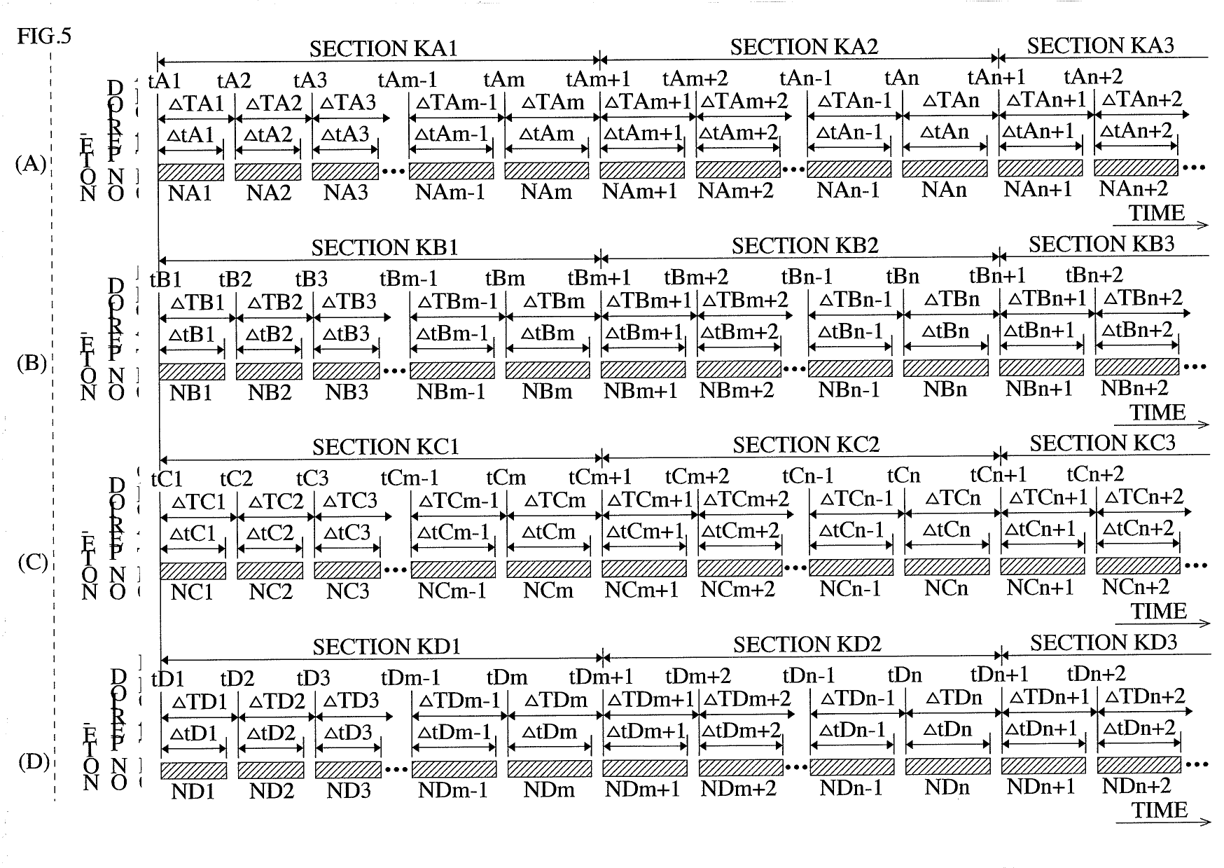

FIGS. 3B to 3E show individual examples of four environmental sounds, each constituted of four chains of phonemes (four tracks), emitted from the four environmental sound generating apparatuses (Generators A, B, C and D), respectively. Specifically, for example, FIG. 3B shows an examples of the environmental sound, constituted of the four chains of phonemes (four tracks), emitted from the associated environmental sound generating apparatus (Generator A). In each of these figures, an ordinate represents phonemes of the primary pitch group on the keys of a keyboard instrument such as a piano, whilst an abscissa represents a time axis. In each of the environmental sound generating apparatuses, the same subgroup is commonly allocated or set to all the temporally corresponding sections of all the tracks, that is, all the sections of all the tracks starting from the same timing. FIG. 3A shows an example of the environmental sound in a case of merging the environmental sounds generated from these four environmental sound generating apparatuses (Generators A, B, C and D). In this case, the phonemes of the plural subgroups are sounded simultaneously in a merged manner and transmitted to listeners.

In this manner, each of the subgroups is constituted by the phonemes selected based on the harmonic theory of the Western music, and the phonemes of the same subgroup are allocated to all the temporally corresponding sections of all the tracks in the environmental sound generating apparatus. In each of the tracks of the environmental sound generating apparatus, phonemes randomly selected from the common subgroup are sequentially sounded one by one for every temporally corresponding section. Basically, as the sound emission timing (phoneme sounding timing) differs for every track, randomness of the sound emission timings and velocities of the phonemes can be more complicated by merging the plural tracks.

In an example, the lengths of all the phonemes (individual phonemes) constituting all the subgroups are set to be the same, for example, about 1,000 ms. A time length of holding a predetermined volume of the phoneme is, for example, about 650 ms after starting the sound emission of this phoneme. Thereafter the volume of this phoneme reduces gradually and disappear (becomes 0) upon the lapse of about 350 ms after starting the reduction. Typically, the sound emission timing (phoneme sounding timing) is set to be different for every track, and the phonemes are sounded with an interval from almost 30 to 150 ms. Thus, typically, a plurality of the phonemes are sounded always in an overlapped manner for each track.

In a certain moment, the plural phonemes are sounded from the plural tracks and from the plural environmental sound generating apparatuses in a manner of holding the individual volumes for a certain time period. As a result, almost all the phonemes of the primary pitch group are sounded simultaneously. However this state is not same as a state where all the phonemes of the primary pitch group are continuously sounded simultaneously. As the sound emission timing (phoneme sounding timing) is typically set to be different for every track, listeners can recognize or notice a time lapse according to the sound. This means that a listener feels a time lapse by accepting or receiving the sound, which is a psychologically important parameter.

Further, as the phonemes sounded from the plural environmental sound generating apparatuses basically belong to different subgroups, the listeners can recognize individual directions of sounds and individual distances from the sound sources. This recognition is also an effective parameter for acceptance ability and data analysis ability with respect to sound originally possessed by persons.

As described above, the length of the phoneme (individual phoneme) is, for example, about 1,000 ms. As the interval of the sound emission of the phonemes (notes) is set to a range from almost 30 to 150 ms, for example, some phonemes are always sounded in an overlapped manner. This is intended to sound the phonemes of pitches simultaneously as many as possible, and there are the following two situations 1) and 2).

The situation 1) is a case of emitting the phonemes of different pitches during sound emission of another phoneme (within the volume holding period), and the situation 2) is a case of emitting the phonemes of the same pitch during sound emission of another phoneme (within the volume holding period),

In the situation 1), the sound emission timings of the phonemes are made differ so as to make listeners recognize or notice a time lapse according to the sound.

An example of the situation 2) is to simultaneously emit plural (e.g., three) phonemes of the same pitch. This case has the similar effect to that of simply emitting a single phoneme having a volume three times as large as that of the plural phonemes.

In the primary pitch group, all the phonemes are set to have the same volume and are emitted with the same velocity. In this case, randomness of the velocities for controlling the volume parameter cannot be achieved. However, the similar effect to that of the randomness of the volume parameter can be achieved by simultaneously emitting the phonemes of the same pitch like the situation 2). In a general automatic performance program, the emission of phonemes of the same pitch in an overlapped manner is not applied to a phoneme of a type holding a volume, and a recreating of the program is required. However, according to the environmental sound generating apparatus according to the invention, the randomness of the volume parameter can be achieved by permitting the simultaneously emission of the phonemes of the same pitch

### First Embodiment

FIG. 4 is a schematic block diagram illustrating an EVS generating apparatus 1 according to a first embodiment of the present invention.

Firstly, the EVS generating apparatus 1 according to the embodiment will be explained. The EVS generating apparatus 1 is constituted of a typical personal computer as a hardware. The environmental sound (EVS) generating apparatus includes a CPU 11, a timer 12, an ROM 13, an RAM 14, a storage unit 15 such as a hard disc, a read/write unit (a unit for reading/writing information from/into a storage medium 17) 16 such as a DVD drive, an operation unit 18 such as a keyboard or a mouse, a display unit 19 such as a liquid crystal panel, a sound source circuit 20, an effect circuit 21, a sound system 22, a communication interface 23 to be connected to a network 100 such as the internet, and a bus 24 for mutually connecting these constituent elements. The timer 12 is connected to the CPU 11 and supplies a basic clock signal, an interruption processing timing, current time etc. to the CPU 11. The communication interface 23 is not necessary if communication with the outside is not required.

Various programs as well as the environmental sound generating program are installed in the storage unit 15 in advance. The CPU 11, etc. can achieve functions, etc. explained below by reading and executing the environmental sound generating program, etc. The computer constituting the EVS generating apparatus according to the present invention is not limited to the personal computer but may be a smartphone or the like.

The sound source circuit 20 generates, under control of the CPU 11, a musical sound signal according to MIDI data sequentially generated in a buffer region of the RAM 14 and supplies the musical sound signal to the sound system 22 via the effect circuit 21. The effect circuit 21 imparts, under the control of the CPU 11, various acoustic effects to the musical sound signal supplied from the sound source circuit 20. Without providing the sound source circuit 20 andthe effect circuit 21, these functions maybe achievedby operating the CPU 11 using the software stored in the storage unit 15, etc. acting as, so-called, a software sound source or effects software. The sound system 22 includes a D/A converter, a speaker, etc. The sound system converts the musical sound signal of a digital format supplied thereto into a signal of an analog format and emits.

The EVS generating apparatus 1 according to the embodiment generates the environmental sound signal representing the environmental sound which forms the sound environment by being emitted. The environmental sound may be a chain of phonemes constituted of individual phonemes which sound-emission start timings as one of attributes thereof are sequentially shifted. In this case, at least one of the attributes of each of the individual phonemes is set to a content selected at random from contents within a selection item range that is set over the entirety of the chain of phonemes or at every section of the chain of phonemes. In this case, at least one of the attributes includes a pitch, and each section of the chain of phonemes belongs to one of the subgroups selected at random as explained below with reference to FIG. 5. Alternatively, the environmental sound may be formed by superimposing a plurality of chains of phonemes (corresponding to plural tracks) each constituted of individual phonemes which are sequentially emittedwith sequentially shifted sound-emission start timings as one of the attributes thereof. In this case, in at least one of the plurality of chains of phonemes, at least one (except for the pitch) of the attributes of each of the individual phonemes is set to a content selected at random from the contents within the selection item range that is set over the entirety of the chain of phonemes or at every section of the chain of phonemes. In this case, at least one of the attributes includes a pitch, and all pitches of the individual phonemes in each section of the chain of phonemes belongs to one of the subgroups selected at random as explained below with reference to FIG. 5. Further, in each of the plurality of chains of phonemes, although at least one (except for the pitch) of the attributes of each of the individual phonemes is preferably set to a content selected at random from the contents within the selection item range that is set over the entirety of the chain of phonemes or at every section of the chain of phonemes, but the present invention is not limited thereto.

Next, a concrete example of the environmental sound will be explained with reference to FIG. 5. In this embodiment, as the environmental sound environmental sound signal is generated utilizing the MIDI data (in particular, SMF (Standard Midi File) of format 1), the concrete example of the environmental sound will be explained using terms (track, note, note number, note-on, note-off, velocity, tone color, effect, continuous data control) in the MIDI data. However, in the present invention, the environmental sound signal is not necessarily generated utilizing the MIDI data but may be generated utilizing one of various kinds of known methods.

FIG. 5 corresponds to one example of the environmental sound generated by the EVS generating apparatus 1 shown in FIG. 4. This figure is a timing chart schematically illustrating an example of note-on periods of the tracks A, B, C and D (see (A) to (D) of this figure). This figure shows an example where the environmental sound generated by the EVS generating apparatus is constituted of the tracks A, B, C and D corresponding to four chains of phonemes. For the sake of simplifying the explanation, hereinafter the explanation is made as to a case where the environmental sound generated by the EVS generating apparatus is constituted of the three chains of phonemes corresponding to the tracks A, B and C.

In FIG. 5, each of individual notes NA of the track A is distinguished by the order of its note-on timing in a manner that the first note, the second note, - - - of the track A are referred to as NA1, NA2, - - - respectively. Supposing that k is an optional integer of 1 or more, in FIG. 5, tAk represents a note-on timing of the k-th note NAk of the track A, ΔtAk represents a note-on period (a period from the note-on timing tAk to a note-off timing of the note NAk: a period from start to termination of sound emission of the note NAk) of the k-th note NAk of the track A, and ΔTAk represents a time interval from the note-on timing tAk of the k-th note NAk of the track A to a note-on timing tAk+1 of the next (k+1)-th note NAk+1 of the track A. Further, in FIG. 5, each of individual sections KAs of the track A is distinguished by the order thereof in a manner that the first section, the second section, - - - of the track A are referred to as KA1, KA2, - - - respectively.

In the similar manner, in FIG. 5, each of individual notes NB of the track B is distinguished by the order of its note-on timing in a manner that the first note, the second note, - - - of the track B are referred to as NB1, NB2, - - - respectively. Supposing that k is an optional integer of 1 or more, in FIG. 5, tBk represents a note-on timing of the k-th note NBk of the track B, ΔtBk represents a note-on period (a period from the note-on timing tBk to a note-off timing of the note NBk) of the k-th note NBk of the track B, and ΔTBk represents a time interval from the note-on timing tBk of the k-th note NBk of the track B to a note-on timing tBk+1 of the next (k+1)-th note NBk+1 of the track B. Further, in FIG. 5, each of individual sections KB of the track B is distinguished by the order thereof in a manner that the first section, the second section,—of the track B are referred to as KB1, KB2,—respectively.

In the similar manner, in FIG. 5, each of individual notes NC of the track C is distinguished by the order of its note-on timing in a manner that the first note, the second note,—of the track C are referred to as NC1, NC2,—respectively. Supposing that k is an optional integer of 1 or more, in FIG. 5, tCk represents a note-on timing of the k-th note NCk of the track C, ΔtCk represents a note-on period (a period from the note-on timing tCk to a note-off timing of the note NCk) of the k-th note NCk of the track C, and ΔTCk represents a time interval from the note-on timing tCk of the k-th note NCk of the track C to a note-on timing tCk+1 of the next (k+1)-th note NCk+1 of the track C. Further, in FIG. 5, each of individual sections KCs of the track C is distinguished by the order thereof in a manner that the first section, the second section,—of the track C are referred to as KC1, KC2,—respectively.

In this embodiment, each of the notes NA, NB and NC includes, as its attribute, the note-on timing tA, tB or tC, the note-off timing (or the note-on period ΔtA, ΔtB or ΔtC), the tone color and the effect. In this embodiment, the pitch is represented by the note number and defined by a pitch name and an octave. For example, the note number representing the pitch defines the pitch name (for example, “C”) and the octave (for example, “3”), whereby the pitch C3, for example, is defined. An example of the effect is reverb, chorus, echo or the like.

Of all the notes NAs of the track A, notes which velocities are set to values other than “0” correspond to individual phonemes constituting the chain of phonemes of the track A. Of all the notes NAs of the track A, each of notes which velocities are set to “0” is silent and does not correspond to an individual phoneme. Thus in this embodiment, if none of the notes NA are allowed to be set to “0” as their velocities, the note-on timing tA of each of all the notes NA is the start timing of sound emission of the individual phoneme. On the other hand, in this embodiment, preferably at least one of the notes NAs is allowed to be set to “0” as its velocity. In this case, the note-on timing tA of each of the notes NAs is a candidate timing as a candidate of the sound-emission start timing of the individual phoneme. Of these candidate timings, the note-on timing tA of each of the notes NAs which velocities are set to values other than “0” is the sound-emission start timing of the individual phoneme. In contrast, the note-on timing tA of each of the notes NAs which velocities are set to “0” is not the sound-emission start timing of the individual phoneme. Incidentally, as described above, the note allocated with R (see FIG. 1) as the phoneme is also silent. This matter is common to each of the notes NB and NC of the tracks B and C.

Supposing that k is an optional integer of 1 or more, the note-off timing of the note NAk of the track A may coincide with the note-on timing tAk+1 of the next note NAk+1, may be earlier than the note-on timing tAk+1 (FIG. 5 shows this state), or may be later than the note-on timing tAk+1. That is, ΔtAk may be same as ΔTAk, ΔtAk may be smaller than ΔTAk (FIG. 5 shows this state), or ΔtAk may be larger than ΔTAk. In this manner, the note-on period ΔtAk of the note NAk of the track A may overlap with the note-on periods of one or more succeeding notes of the track A, may not overlap with but continue to the note-on period ΔtAk+1 of the next note NAk+1, or may not overlap with or continue to the note-on period ΔtAk+1 of the next note NAk+1. This matter is common to each of the notes NB and NC of the tracks B and C. Incidentally, in this embodiment, preferably the continuous note-on periods are overlapped as described above.

Supposing that k is an optional integer of 1 or more, usually individual phonemes are continuously generated over the entire note-on period ΔtAk of the note NAk which velocity is set to a value other than “0”. However depending on tone color set to the note NAk, the individual phenome having started sound-emission at the note-on timing tAk sometimes vanishes before the note-off timing of the note NAk. Further supposing that k is an optional integer of 1 or more, usually constant sound pitch represented by the pitch set to the note NAk is maintained over the entire note-on period ΔtAk of the note NAk which velocity is set to a value other than “0”. However sound pitch actually generated sometimes changes depending on tone color or continuous data control set to the note NAk. This matter is common to each of the notes NB and NC of the tracks B and C.

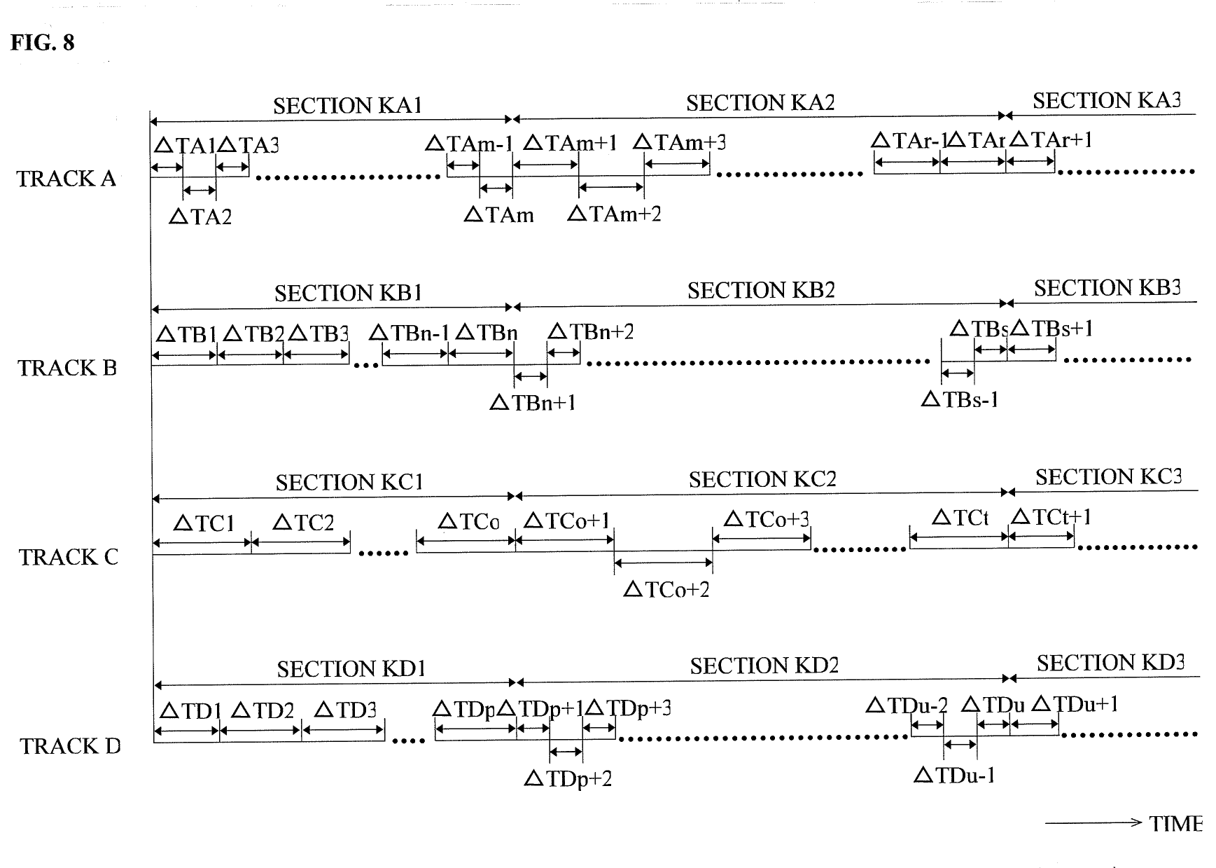

The environmental sound being generated is formed by superimposing three chains of phonemes corresponding to the tracks A, B and C. The track A is divided in the first section KA1, the second section KA2, the third section KA3, - - - . The track B is divided in the first section KB1, the second section KB2, the third section KB3, - - - . Similarly the track C is divided in the first section KC1, the second section KC2, the third section KC3, - - - . Lengths and timings may differ between the sections KA1, KA2, KA3, - - - of the track A, the sections KB1, KB2, KB3, - - - of the track B and the sections KC1, KC2, KC3, - - - of the track C. That is, lengths and timings of the sections of each of these tracks may be set to individual values each selected randomly from a predetermined range of value. Preferably, in this embodiment, as explained later with reference to FIGS. 5 and 8, lengths, start timings and termination timings of the temporally corresponding sections are made coincide to each other between these tracks.

The lengths of the individual sections KA, KB and KC may be determined by the numbers or periods of the notes NA, NB and NC, respectively. The length of each of the sections KA, KB and KC may be set to an optional time, for example, in a range from 1 second or less to several hours or more. Incidentally one or both of the tracks A and B may be divided into plural sections. For example, in a case where the track A is not divided into plural sections, the setting described later relating to the section KA of the track A may be applied to the entire sections of the track A.

The lengths of the individual sections of the track A may be the same to each other, may change in a constant pattern (for example, supposing that L1 to L3 are individual different lengths, L1 to L3 repeat cyclically, or L1 and L2 repeat alternately), or may be set to values each selected randomly from a predetermined range of value. In a case where the lengths of the individual sections of the track A are set to values each selected randomly from the predetermined range of value, if L1 to L3 are individual different lengths, each of the individual sections of the track A may be set to a value selected randomly from L1 to L3. In this case, selection probabilities of L1 to L3 may be the same or optional individual values. For example, using pseudorandom numbers in which natural numbers from 1 to 100 appear randomly with the same probability, a number appeared from 1 to 15 is converted into L1, a number appeared from 16 to 50 is converted into L2, and a number appeared from 51 to 100 is converted into L3. As a result, from L1 to L3, L1 can be selected with a probability of 15%, L2 can be selected with a probability of 35%, and L3 can be selected with a probability of 50%. Further, for example, in a case of setting the selection probabilities of L1, L2 and L3 so as to be 2:3:4, using pseudorandom numbers in which natural numbers from 1 to 9 (=2+3+4) appear randomly with the same probability, a number appeared from 1 to 2 may be converted into L1, a number appeared from 3 to 5 may be converted into L2, and a number appeared from 6 to 9 may be converted into L3. Lengths of succeeding plural sections KA may be allowed to be the same value accidentally, or may be selected randomly from the predetermined range under a condition that lengths of a predetermined number (an optional number of 2 or more) of succeeding sections KA are not the same. This matter is common to each of the tracks B and C.

Although the number of the tracks is four in the example shown in FIG. 5, the number of the tracks may be one, two, three, or five or more. That is, the environmental sound generated by the EVS generating apparatus 1 according to the first embodiment may be formed by only one chain of phonemes corresponding to one track, or may be formed by two or more chains of phonemes corresponding to two or more tracks.

The time intervals ΔTA1 to ΔTAm between adjacent ones of the note-on timings tAl to tAm of the notes NA1 to NAm of the section KA1 may be the same (ΔTA1=ΔTA2=- - - =ΔTAm), may change in a constant pattern (for example, supposing that ΔT1 to ΔT4 are individual different time intervals, ΔT1 to ΔT4 repeat cyclically, or ΔT1 and ΔT2 repeat alternately), or may be set to values each selected randomly from a predetermined range of value. In a case where the individual time intervals ΔTA1 to ΔTAm are set to values each selected randomly from the predetermined range of value, if ΔT1 to ΔT3 are individual different time intervals, each of the individual time intervals ΔTA1 to ΔTAm may be set to a value selected randomly from ΔT1 to ΔT3. In this case, selection probabilities of ΔT1 to ΔT3 may be the same or optional individual values. Succeeding plural time intervals ΔTA of the section KA1 may be allowed to be the same accidentally, or may be selected randomly from the predetermined range under a condition that succeeding predetermined number (an optional number of 2 or more) of time intervals ΔTA of the section KA1 are not the same. This matter is common to each of the sections KA other than the section KA1 of the track A, each of the sections KB of the track B and each of the sections KC of the track C.

Preferably, the note-on periods ΔtA1 to ΔtAm of the individual notes NA1 to NAm of the section KA1 of the track A are typically the same (ΔtA1=ΔtA2=- - - =ΔtAm). In a typical example, the note-on periods ΔtAn (n=1 - - - m) (period during which volume level is more than 0) have the same time length, that is, about 1,000 ms, for example. In the note-on period, a sound level holding period, during which a predetermined sound level is maintained, continues about 650 ms, then the sound level reduces gradually and reaches 0 upon a lapse of about 350 ms after termination of the sound level holding period. These note-on periods may change in a constant pattern (for example, supposing that Δt1 to Δt5 are individual different periods, Δt1 to Δt5 repeat cyclically, or Δt1 and Δt2 repeat alternately), or may be set to values each selected randomly from a predetermined range of value.

In a case where the individual note-on periods ΔtA1 to ΔtAm are set to values each selected randomly from the predetermined range of value, if Δt1 to Δt3 are individual different periods, each of the individual periods ΔtA1 to ΔtAm may be set to a value selected randomly from Δt1 to Δt3. In this case, selection probabilities of Δt1 to Δt3 may be the same or optional individual values. Succeeding plural note-on periods ΔtA of the section KA1 may be allowed to be the same accidentally, or may be selected randomly from the predetermined range under a condition that succeeding predetermined number (an optional number of 2 or more) of note-on periods ΔtA of the section KA1 are not the same. This matter is common to each of the sections KA other than the section KA1 of the track A, each of the sections KB of the track B and each of the sections KC of the track C.

The velocity of each of the notes NA1 to NAm of the section KA1 of the track A may be set to a value other than “0”. In this case, each of the notes NA1 to NAm of the section KA1 is not silent and corresponds to an individual phoneme. Thus each of the note-on timings tA1 to tAm of the section KA1 becomes the sound-emission start timing of the corresponding individual phoneme. Typically the velocity of each of the notes NA1 to NAm of the section KA1 is randomly set to “0” or a value other than “0”, preferably. In this case, velocities of succeeding plural notes NA of the section KA1 may be allowed to the same value of “0” accidentally, or may each be randomly set to “0” or a value other than “0” under a condition that a velocity of each of a predetermined number (an optional number of 2 or more) of succeeding notes NA of the section KA1 is not “0”. This matter is common to each of the sections KA other than the section KA1 of the track A, each of the sections KB of the track B and each of the sections KC of the track C.

Of the velocities of the notes NA1 to NAm of the section KA1 of the track A, velocities each set to a value other than “0” may be the same value or may change in a constant pattern (for example, supposing that V1 to V4 are individual different values other than “0”, V1 to V4 repeat cyclically, or V1 and V2 repeat alternately), or may be set to values each selected randomly from a predetermined range of value other than “0”. In a case where the individual velocities of the notes NA1 to NAm each to be set to a value other than “0” are set to values selected randomly from the predetermined range of value other than “0”, if V1 to V3 are individual different values other than “0”, each of the individual velocities may be set to a value selected randomly from V1 to V3. In this case, selection probabilities of V1 to V3 may be the same or optional individual values. Succeeding plural velocities of the section KA1 may be allowed to be the same accidentally, or may be selected randomly from the predetermined range of value other than “0” under a condition that velocities other than “0” of succeeding predetermined number (an optional number of 2 or more) of notes of the section KA1 are not the same. This matter is common to each of the sections KA other than the section KA1 of the track A, each of the sections KB of the track B and each of the sections KC of the track C.

With respect to each of the individual sections KA1, KA2, KA3, - - - of the track A, one subgroup is randomly selected from nine subgroups of the primary pitch group and allocated. In this case, preferably, the one subgroup randomly selected regarding the section KA1 of the track A is commonly allocated or set to the sections KB1 and KC1 of the tracks B and C temporally corresponding to the section KA1 of the track A. This setting is also performed regarding each of the sections KA other than the section KA1 of the track A, each of the sections KB of the track B and each of the sections KC of the track C.

Further, regarding each note of each section in each track, a pitch randomly selected from plural kinds of pitches of the selected subgroup is set.

Specifically, for example, regarding all the notes NA1 to NAm of the section KA1, pitches each randomly selected from the plural kinds of pitches of the subgroup selected randomly regarding the section K1 are set. In this respect, of all the notes NA1 to NAm, as a note which velocity is set to “0” is silent, a pitch is not necessarily set to this note. Alternatively an optional constant pitch may be set to this note.

This setting is also performed regarding each of the sections KA other than the section KA1 of the track A, each of the sections KB of the track B and each of the sections KC of the track C.

Tone colors of the individual notes NA1 to NAm of the section KA1 of the track A may be the same to each other, may change in a constant pattern (for example, supposing that Q1 to Q3 are individual different tone colors, Q1 to Q3 repeat cyclically, or Q1 and Q2 repeat alternately), or may be set to tone colors each selected randomly from plural kinds of tone colors. In the last case, selection probabilities of the plural kinds of tone colors may be the same or optional individual values. This setting is also performed regarding each of the sections KA other than the section KA1 of the track A, each of the sections KB of the track B and each of the sections KC of the track C.

With respect to each of the notes NA1 to NAm of the section KA1 of the track A, effect may be added or may not be added. In a case of adding effect to each of the notes NA1 to NAm of the section KA1, kinds of individual effect added to the notes NA1 to NAm may be the same to each other, may change in a constant pattern (for example, supposing that U1 to U3 are individual different effect, U1 to U3 repeat cyclically, or U1 and U2 repeat alternately), or may be set to individual kinds each selected randomly from plural kinds of effect. In the last case, selection probabilities of the plural kinds of effect may be the same or optional individual values. Further, in a case of adding effect to each of the notes NA1 to NAm of the section KA1, degrees of individual effect added to the notes NA1 to NAm may be the same to each other, may change in a constant pattern (for example, supposing that W1 to W3 are individual different degrees, W1 to W3 repeat cyclically, or W1 and W2 repeat alternately), or may be set to individual degrees each selected randomly from a predetermined range of degree. This setting is also performed regarding each of the sections KA other than the section KA1 of the track A, each of the sections KB of the track B and each of the sections KC of the track C.

With respect to each of the notes NA1 to NAm of the section KA1 of the track A, continuous data control may be added or may not be added. Continuous data control may be added on a single phoneme basis, or may be added on a plural phoneme basis so that continuous data control change gradually over the plural phonemes. Continuous data control acts to change pitch, velocity, tone color, etc. continuously in a case of changing expression, pitch bend, modulation depth, panpot, filter or the like. This matter is also applied to each of the sections KA other than the section KA1 of the track A, each of the sections KB of the track B and each of the sections KC of the track C.

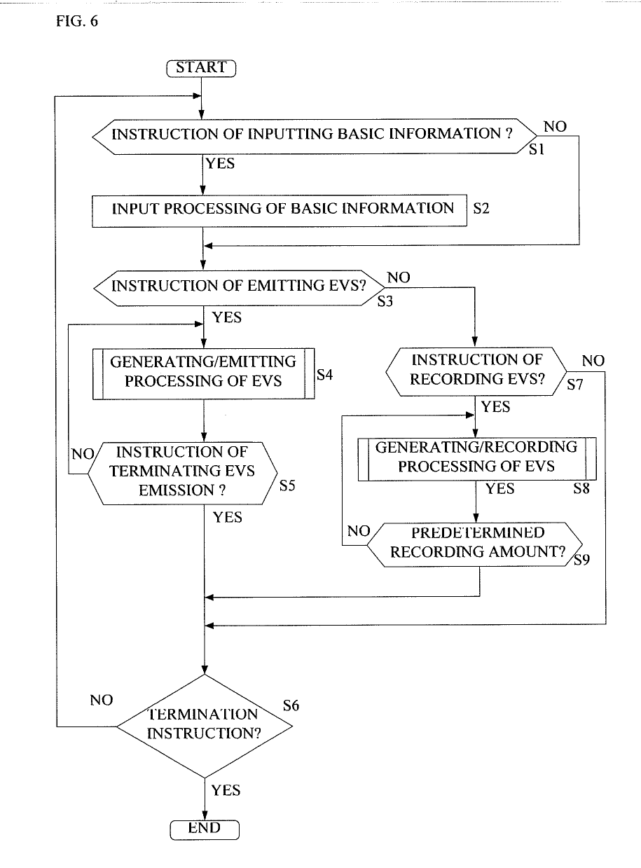

FIG. 6 is a schematic flowchart showing an example of an operation of the EVS generating apparatus 1 according to this embodiment.

When the operation of the EVS generating apparatus 1 according to this embodiment starts, the CPU 11 firstly determines whether or not an instruction (basic information input instruction) of inputting basic information as a basis for generating the environmental sound is received from the operation unit 18 (step S1). If determination is made that the basic information input instruction is received, the processing proceeds to step S2. In contrast, if determination is made that the basic information input instruction has not been received, the processing proceeds to step S3.

In step S2, the CPU 11 performs an input processing of the basic information. That is, the CPU 11 successively displays, on the display unit 19, a guide for urging a user to input the basic information. The UPU 11 stores the basic information inputted from the operation unit 18 in response to an operation of the user according to the guide, into the storage unit 15 as a file. In this respect, entirety of individual information for generating single kind of environmental sound constitutes single piece of basic information. In this embodiment, a single file is formed at every single piece of basic information.

Specifically the basic information contains, for example, (i) information for determining the number of tracks, (ii) information for determining the sections in each of the tracks, (iii) information for determining the individual note-on timings in each section of each track, (iv) information for determining the note-on period of each note in each section of each track, (v) information for determining whether or not the velocity of each note in each section of each track is set to “0” (that is, whether or not the note is set to be silent), (vi) information for determining values of the individual velocities each to be set to a value other than “0” among the velocities of individual notes in each section of each track, (vii) information for determining pitch of each note in each section of each track, (viii) information for determining tone color of each note in each section of each track, (ix) information for determining effect of each note in each section of each track, and (x) information for determining continuous data control in each section of each track.

The number of tracks of the information (i) is 1 or 2 or more, and preferably 3 or more.

The information (ii) is information for each track, and contains, for example: information representing whether or not the track is divided into plural sections; information representing, in a case of dividing the track into plural sections, whether the length (the length may be the number of notes or a time period) of each section of this track is set to be the same as or irrespective of the length of each section of the other tracks; information representing, in a case of dividing the track into plural sections and setting the length of each section of this track irrespective of each section of the other tracks, whether the lengths of individual sections of this track are set in a constant pattern or set to values randomly selected from the predetermined range; information for specifying the pattern (equalizing the lengths of individual sections or alternately repeating plural different lengths, and designation of these lengths) in the case of setting the lengths of individual sections of this track to the constant pattern; and information representing plural lengths constituting the predetermined range and selection probabilities thereof (or a ratio of the selection probabilities or the like) in the case of setting the lengths of individual sections of this track to values randomly selected from the predetermined range (if necessary, this information may be added with information representing whether or not a condition, that lengths of succeeding predetermined number (an optional number of 2 or more) of sections are not the same, is assigned).

In this embodiment, typically the lengths of individual sections of each track are set to values randomly selected from the predetermined range, respectively. Preferably, as explained later with reference FIG. 8, lengths, start timings and termination timings of the temporally corresponding sections are made coincide between the tracks.

The information (iii) is information for each track and each section (however in a case of not dividing each track into plural sections, this information is not information for each section but information for the entirety of the track), and contains, for example: information representing whether the time intervals between individual adjacent ones of the note-on timings in this section of this track are set to a constant pattern or set to values randomly selected from the predetermined range; information for specifying the pattern (equalizing the time intervals between individual adjacent note-on timings or alternately repeating plural different time intervals, and designation of these time intervals) in the case of setting the time intervals between individual adjacent note-on timings in this section of this track to the constant pattern; and information representing plural time intervals constituting the predetermined range and selection probabilities thereof (or a ratio of the selection probabilities or the like) in the case of setting the time intervals between individual adjacent note-on timings in this section of this track to values randomly selected from the predetermined range (if necessary, this information may be added with information representing whether or not a condition, that time intervals of succeeding predetermined number (an optional number of 2 or more) of note-on timings in this section of this track are not the same, is assigned).

In this embodiment, preferably, as explained later with reference to FIG. 8, the time intervals between individual adjacent note-on timings may be set to a constant in all the sections of each track, or may be made different at every section in each track. In this respect, preferably the time intervals between individual adjacent note-on timings are different between the plural tracks.

The information (iv) is information for each track and each section, and contains, for example: information representing whether the note-on periods of individual notes in this section of this track are set to a constant pattern or set to values randomly selected from the predetermined range; information for specifying the pattern (equalizing the note-on periods of the individual notes or alternately repeating plural different periods, and designation of these periods) in the case of setting the note-on periods of individual notes in this section of this track to the constant pattern; and information representing plural periods constituting the predetermined range and selection probabilities thereof (or a ratio of the selection probabilities or the like) in the case of setting the note-on periods of individual notes in this section of this track to values randomly selected from the predetermined range (if necessary, this information may be added with information representing whether or not a condition, that time lengths of succeeding predetermined number (an optional number of 2 or more) of note-on periods in this section of this track are not the same, is assigned).

In this embodiment, typically the note-on periods of all the tacks may have the same time length.

The information (v) is information for each track and each section, andcontains, for example: information representingwhether the velocities of all the notes in this section of this track are set to individual values other than “0” or the velocity of each of these notes is randomly set to “0” or a value other than “0”; and information representing a selection probability of “0” (or selection probabilities of individual values other than “0”) in the case of randomly setting the velocity of each of the notes in this section of this track to “0” or a value other than “0” (if necessary, this information may be added with information representing whether or not a condition, that velocities of succeeding predetermined number (an optional number of 2 or more) of notes in this section of this track are other than “0”, is assigned).

In this embodiment, typically the velocity of each of all the notes in each section of each track is randomly set to “0” or a value other than “0”.

The information (vi) is information for each track and each section, andcontains, for example: information representingwhether the velocities of individual notes each to be set to a value other than “0” in this section of this track are set to a constant pattern or set to values other than “0” randomly selected from the predetermined range; information for specifying the pattern (equalizing the values of velocities of individual notes or alternately repeating plural different values, and designation of these values) in the case of setting the velocities of individual notes each to be set to a value other than “0” in this section of this track to the constant pattern; and information representing plural values constituting the predetermined range and selection probabilities thereof (or a ratio of the selection probabilities or the like) in the case of setting the velocities of individual notes each to be set to a value other than “0” in this section of this track to values other than “0” randomly selected from the predetermined range (if necessary, this information may be added with information representing whether or not a condition, that velocities other than “0” of succeeding predetermined number (an optional number of 2 or more) of notes in this section of this track are not the same, is assigned).

In this embodiment, the velocities of individual notes each to be set to a value other than “0” may be set to a constant value.

The information (vii) is information for each track and each section, and contains, for example: information for allocating one subgroup randomly selected from the plurality (e.g., nine) subgroups of the primary pitch group to this section of this track; information for allocating one pitch randomly selected from the allocated subgroup regarding each of all the notes in this section of this track; and information whether or not, regarding each of temporally corresponding (or same) sections of all the tracks, the subgroup randomly selected from the primary pitch group is commonly applied.

The information (viii) is information for each track and each section, and contains, for example: information representing whether the tone colors of individual notes in this section of this track are set to a constant pattern or set to tone colors randomly selected from the predetermined range; information for specifying the pattern (equalizing the tone colors of the individual notes or alternately repeating plural different tone colors, and designation of these tone colors) in the case of setting the tone colors of individual notes in this section of this track to the constant pattern; and information representing plural tone colors constituting the predetermined range and selection probabilities thereof (or a ratio of the selection probabilities or the like) in the case of setting the tone colors of individual notes in this section of this track to values randomly selected from the predetermined range (if necessary, this information may be added with information representing whether or not a condition, that tone colors of succeeding predetermined number (an optional number of 2 or more) of notes in this section of this track are not the same, is assigned).

The information (ix) is information for each track and each section, and contains, for example: information representing whether or not the effect is added to all the notes in this section of this track; information representing, in a case of adding the effect to all the notes in this section of this track, whether the kinds of individual effect added to all the notes in this section of this track are set in a constant pattern or selected randomly from the plural kinds of effect constituting a predetermined range; information for specifying the pattern (equalizing the kinds of effect of all the notes or alternately repeating plural different kinds of effect, and designation of these kinds) in the case of setting the kinds of effect of all the notes in this section of this track to the constant pattern; information representing the plural kinds of effect constituting the predetermined range and selection probabilities thereof (or a ratio of the selection probabilities or the like) in the case of randomly selecting the kinds of effect of all the notes in this section of this track from the plural kinds of effect constituting the predetermined range; information representing, in a case of adding the effect to all the notes in this section of this track, whether degrees of individual effect added to all the notes in this section of this track are set in a constant pattern or selected randomly from plural degrees of effect constituting a predetermined range; information for specifying the pattern (equalizing the degrees of effect of all the notes or alternately repeating plural different degrees of effect, and designation of these degrees) in the case of setting the degrees of effect of all the notes in this section of this track to the constant pattern; and information representing the plural degrees of effect constituting the predetermined range and selection probabilities thereof (or a ratio of the selection probabilities or the like) in the case of randomly selecting the degrees of effect of all the notes in this section of this track from the plural kinds of effect constituting the predetermined range

The information (x) is information for each track and each section, andcontains, for example: information representing whether or not the continuous data control is added to all the notes in this section of this track; information representing, in a case of adding the continuous data control to all the notes in this section of this track, the number of succeeding phonemes to which the same continuous data control is added commonly as a single unit; and information representing kinds of the continuous data control.

When the processing (input processing the single basic information) of step S2 in FIG. 6 terminates, the processing proceeds to step S3. Incidentally if there exists the basic information already, in step S2, the contents of already-existing basic information may be displayed on the display unit 19 so that this basic information may be suitably modified or arranged partially and inputted as another basic information.

In step S3, the CPU 111 determines whether or not an instruction (environmental sound generation instruction) of generating an environmental sound according to the piece of basic information selected from the storage unit 15 is received from the operation unit 18. If determination is made that the environmental sound generation instruction is received, the processing proceeds to step S4. In contrast, if determination is made that the environmental sound generation instruction is not received, the processing proceeds to step S7.

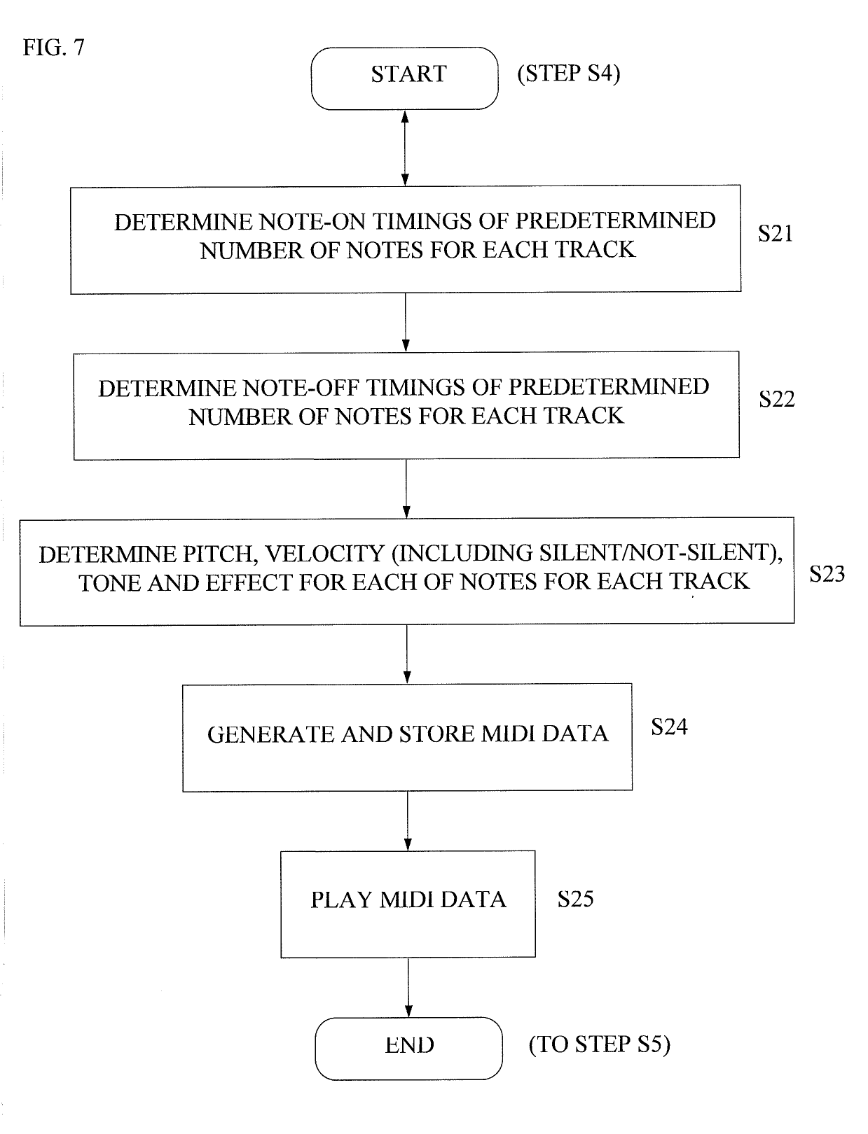

In step S4, the CPU 11 performs an environmental sound generating/emitting processing according to the piece of basic information selected in step S3. FIG. 7 is a schematic flowchart illustrating an operation of step S4 of FIG. 6. In this embodiment, step S4 and step S8 described later corresponds to processing performed by an environmental sound generating/emitting means.

When the environmental sound generating/emitting processing of step S4 is started, the CPU 11 determines a note-on timing for each of the predetermined number of notes for each track, according to the piece of basic information selected in step S3 (step S21).

Next, the CPU 11 determines a note-off timing for each of the notes processed in step S21, according to the piece of basic information selected in step S3 (step S22).

Then the CPU 11 determines a pitch set based on the selected subgroup, a velocity (“0” or a value other than “0”), tone color, effect and, if necessary, continuous data control for each of the notes processed in step S21, according to the piece of basic information selected in step S3 (step S23).

In steps S21 to S23, the CPU 11 may set or allocate the pitches, etc., randomly according to the piece of basic information selected in step S3 using the pseudorandom numbers.

These processing of steps S21 to S23 is performed for each track. In this embodiment, steps S21 to S23 corresponds to processing performed by an attribute setting means for setting contents of the attribute of each of the individual phonemes of the environmental sound.

After step S23, the CPU 11 generates MIDI data for each track based on the note-on timings of the predetermined number of notes determined in step S21, the note-off timings of the predetermined number of notes determined in step S22, and the pitches, velocities, tone colors, effects and continuous data controls of the predetermined number of notes determined in step S23, and stores this MIDI data for each track in the buffer area of the RAM 14 (step S24).

Succeedingly, the CPU 111 sequentially reads the MIDI data for each track stored in the buffer area of the RAM 14 and plays the MIDI data (step S25). In this case, the CPU 111 controls the sound source circuit 20 and the effect circuit 21 according to the MIDI data for each track and supplies a sound signal of digital format for each track representing the MIDI data to the sound system 22. The sound system 22 converts the sound signal of digital format for each track into a sound signal of analog format for each track, then synthesizes and emits the sound signals of analog format of individual tracks as an environmental sound generated according to the piece of basic information selected in step S3.

After completion of step S25, the processing proceeds to step S5 of FIG. 6. In step S5, the CPU 11 determines whether or not an instruction of terminating the emission of the environmental sound is received from the operation unit 18. If determination is made that the instruction of terminating the emission of the environmental sound is not received, the processing returns to step S4 (that is, step S21). In contrast, if determination is made that the instruction of terminating the emission of the environmental sound is received, the processing proceeds to step S6.

For the sake of simplifying the drawing, step S25 of FIG. 7 is represented so as to be executed after step S24. However, in fact, after executing the MIDI data generating processing of the first time in step S24, the MIDI data playing processing is suitably executed as an interruption processing during the processing of optional one of step S5 and steps S21 to S24 so that the playing of this MIDI data is not interrupted. Further, an amount of the MIDI data stored in the buffer area of the RAM 14 in step S24 is preferably set to be equal to or larger than an amount of the MIDI data subjected to the playing processing so that the playing of this MIDI data is not interrupted.

In step S6, the CPU 11 determines whether or not an instruction of terminating the entire processing of the EVS generating apparatus is received from the operation unit 18. If determination is made that the instruction of terminating the entire processing of apparatus is not received, the processing returns to step S1. In contrast, if determination is made that the instruction of terminating the entire processing of apparatus is received, the entire processing of apparatus is terminated.

In step S6, the CPU 11 determines whether or not an instruction (environmental sound recording instruction) of recording into the storage medium 17 an environmental sound according to the piece of basic information selected from the storage unit 15 is received from the operation unit 18. If determination is made that the environmental sound recording instruction is received, the processing proceeds to step S8. In contrast, if determination is made that the environmental sound recording instruction is not received, the processing proceeds to step S6.

In step S8, the CPU 11 performs an environmental sound generating/recording processing according to the piece of basic information selected in step S7. This environmental sound generating/recording processing of step S8 is modification of the environmental sound generating/emitting processing (that is, steps S21 to S25) of step S4 as explained below.

Also in step S8, the CPU 11 performs processing similar to that of steps S21 to S24 according to the piece of basic information selected in step S7. Then in step S8, after the processing of step S24, the CPU 11 performs, in place of the processing of step S25, processing of controlling the read/write unit 16 to write in the storage medium 17 the MIDI data stored in the buffer area of the RAM 14 in step S24. Thereafter the CPU 11 terminates the processing of step S8 and proceeds the processing to step S9. In this manner, according to this embodiment, the MIDI data is stored in the storage medium 17 as the environmental sound signal representing the environmental sound. Alternatively, after the processing of step S24, the CPU 11 may execute the MIDI data playing processing of step S25 (this processing may not necessarily be the interruption processing) and record a sound signal of digital format (digital signal of MP3 format or CD format) obtained from the effect circuit 21 in the storage medium 17 as the environmental sound signal representing the environmental sound.

In a case of the storage medium 17 recording the MIDI data as the environmental sound, the MIDI data can be played and emitted as the environmental sound representing the MIDI data using a personal computer, various kinds of musical instruments or the like. In a case of the storage medium 17 recording the sound signal of digital format as the environmental sound, the sound signal can be reproduced and emitted as the environmental sound representing the sound signal using a personal computer, a music player or the like.

After step S8, the CPU 11 determines whether or not an amount of data or signal recorded in the storage medium 17 in step S8 reaches a predetermined recording amount (step S9). If determination is made that the recording amount does not reach the predetermined recording amount, the processing returns to step S8. In contrast, if determination is made that the recording amount reaches the predetermined recording amount, the processing proceeds to step S6.

According to this embodiment, a user can input the various kinds of basic information as described in step S2 and can emit in step S4 the environmental sound represented by the environmental sound signal which is generated according to the inputted basic information. The environmental sound thus emitted can be used for trial listening upon generating the basic information. Further when the sound system 22 or another sound system such as an amplifier or a speaker connected thereto is disposed at an optional place (for example, a waiting room and a consulting room of a hospital, an office, a lecture room, a conference room, a library, a tearoom, or the like) required to form the sound environment, the sound environment can be formed therein by emitting the environmental sound.

According to this embodiment, as the at least one attribute (pitch in this case) of the individual phonemes is set to the content selected at random, the environmental sound constituted of plural series of the individual phonemes away from music can be generated. Thus the EVS generating apparatus according to this embodiment can generate the environmental sound (specifically, the environmental sound signal representing the environmental sound) that can, as compared with reproduced sound such as BGM or natural sound added with pink noise or the like, cancel other person's talk and noise, etc. unnecessary for remaining persons to create a quiet state and/or relieve tension to bring a mentally gentle state, without separating many people into those who likes and feel pleasure of the sound and those who do not like or feel pleasure of the sound. Consequently as the at least one attribute (pitch in this case) of the individual phonemes is set to the content selected at random, the generated environmental sound is unlikely attract attention of persons. Thus when sound information to be noticed by persons is emitted simultaneously with or before/after the environmental sound, the sound information can be conspicuous from the environmental sound and listened easily.

Further according to this embodiment, as the notes of each section of each track are randomly set to individual pitches selected randomly from the pregiven plural kinds of pitches. That is, one of the plural (nine in this case) subgroups is selected randomly and commonly allocated or set to all the temporally corresponding sections of all the tracks. Further the notes of each of the temporally corresponding sections are randomly set to individual pitches selected randomly from the selected subgroup.

By doing so, the chains of phonemes of the individual tracks as shown in FIGS. 3B to 3E are generated. In this manner, the pitches as the attribute to be noticed particularly among all the attributes of the individual phonemes are set randomly. Thus the environmental sound can be generated that can cancel other person's talk and noise, etc. unnecessary for remaining persons to create a quiet state and/or relieve tension to bring a mentally gentle state, without separating many people into those who likes and feel pleasure of the sound and those who do not like or feel pleasure of the sound.

In particularly, in a case of providing a plurality of such the tracks, a merged sound of the chains of phonemes from these tracks cannot be recognized as a dissonance and can attain the aforesaid effect effectively.

FIG. 8 is a conceptual diagram illustrating an example of an environmental sound constituted of four tracks A to D. In FIG. 8, as to the first section KA1 of the track A, the phonemes randomly selected from the subgroup commonly allocated to the temporally corresponding sections KA1, KB1, KC1 and KD1 are emitted with a pregiven time interval (ΔTAk: k=1 to m) between the adjacent note-on timings, for example, emitted 60 times (i.e., m=60) with the time interval of 100 ms. Similarly as to the first section KB1 of the track B, the phonemes randomly selected from the commonly allocated subgroup are emitted with a pregiven time interval (ΔTBk: k=1 to n), for example, emitted 30 times (i.e., n=30) with the time interval of 200 ms. Similarly as to the first section KC1 of the track C, the phonemes randomly selected from the commonly allocated subgroup are emitted with a pregiven time interval (ΔTCk: k=1 to o), for example, emitted 20 times (i.e., o=20) with the time interval of 300 ms. Similarly as to the first section KD1 of the track D, the phonemes randomly selected from the commonly allocated subgroup are emitted with a pregiven time interval (ΔTDk: k=1 to p), for example, emitted 25 times (i.e., p=25) with the time interval of 240 ms.

In each of the tracks A to D, the lengths of all the phonemes (individual phonemes) are set to be the same, for example, about 1,000 ms. Although, basically, the number of the phonemes in each section of each track is set randomly, the start timings and termination timings of the temporally corresponding sections are made coincide to each other between these tracks. That is, the numbers of the phonemes of these temporally corresponding sections (KA1, KB1, KC1 and KD1) are set so that the time lengths of these sections are the same.

As to the second section KA2 of the track A, the phonemes randomly selected from the subgroup commonly allocated to the temporally corresponding sections KA2, KB2, KC2 and KD2 are emitted with a pregiven time interval (ΔTAk: k=1 to r) between the adjacent note-on timings, for example, emitted 50 times (i.e., r=50) with the time interval of 200 ms. Similarly as to the second section KB2 of the track B, the phonemes randomly selected from the commonly allocated subgroup are emitted with a pregiven time interval (ΔTBk: k=1 to s), for example, emitted 100 times (i.e., s=100) with the time interval of 200 ms. Similarly as to the second section KC2 of the track C, the phonemes randomly selected from the commonly allocated subgroup are emitted with a pregiven time interval (ΔTCk: k=1 to t), for example, emitted 40 times (i.e., t=40) with the time interval of 250 ms. Similarly as to the second section KD1 of the track D, the phonemes randomly selected from the commonly allocated subgroup are emitted with a pregiven time interval (ΔTDk: k=1 to u), for example, emitted 80 times (i.e., u=80) with the time interval of 125 ms. Also in this case, the start timings and termination timings of the temporally corresponding sections (KA2, KB2, KC2 and KD2) are made coincide to each other between these tracks. That is, the numbers of the phonemes of these temporally corresponding sections are set so that the time lengths of these sections are the same.

As to the succeeding sections (KA3, KB3, KC3, KD3, - - - ) of the tracks A to D, the environmental sound is generated in the similar manner

Preferably the time length of each section is set to about 3.78 seconds which corresponds to four times of the beating of the human heart.

### Second Embodiment

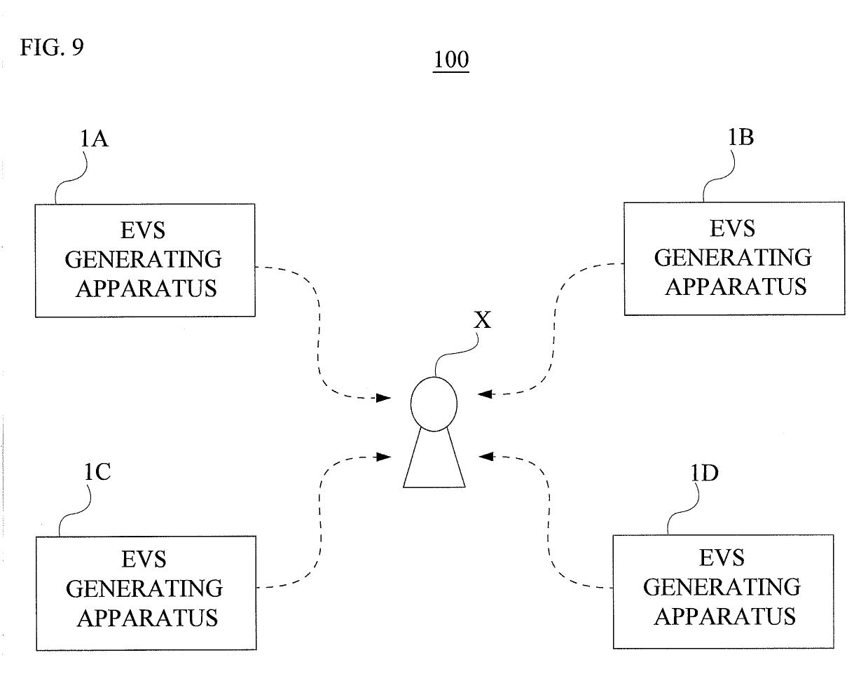

FIG. 9 is a schematic block diagram illustrating an EVS generating system 100 according to a second embodiment of the present invention which is arranged to surround a predetermined space by a plurality of (preferably four) the EVS generating apparatuses 1. The configuration of each of these EVS generating apparatuses 1 is same as that of the EVS generating apparatus 1 of the first embodiment.

Each of the EVS generating apparatuses 1 generates the environmental sound of at least one track, preferably three tracks. Each of the EVS generating apparatuses 1 generates the environmental sound independently from the remaining EVS generating apparatuses 1.

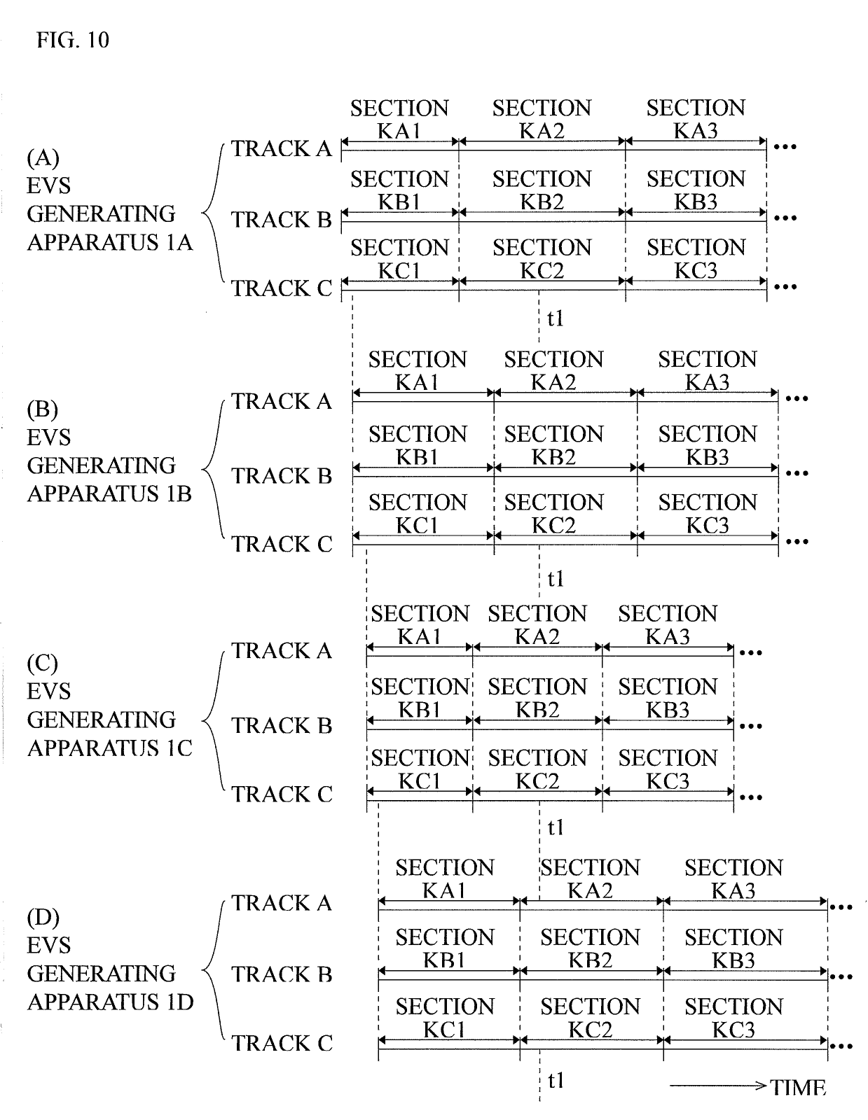

FIG. 10 shows an example of the environmental sound in a case where each of the four EVS generating apparatuses 1A, 1B, 1C and 1D emits the chains of phonemes of three tracks.

In this case, the environmental sound generated from each of the EVS generating apparatuses 1A, 1B, 1C and 1D is substantially same as that shown in FIG. 8 except for that the number of the tracks is three in this case. In this embodiment, the emission start timings of the environmental sounds generated from the EVS generating apparatuses 1A to 1D may be at random. In the same EVS generating apparatus 1, the phonemes randomly selected from the subgroup commonly allocated to the temporally corresponding sections of the three tracks are emitted. However, basically, the phonemes of other subgroups are emitted at different timings from the other EVS generating apparatuses.

For example, the subgroups and the time intervals between adjacent note-on timings of the environmental sound generated at a time t1 are basically different among the EVS generating apparatuses 1A to 1D. This is applicable to the other time points.

In the object space surrounded by the plural EVS generating apparatuses, the environmental sounds of different subgroups are basically always generated simultaneously and transmitted to listeners from different directions. Thus as the randomness of the pitches, etc., can be enhanced as compared with a case of listening the environmental sound generated from the single EVS generating apparatus, a degree of noticing the sound can be reduced, and hence the environmental sounds cannot be listened or recognized as noise for listeners, thereby not imparting unpleasant feeling to the listeners. This effect can be enhanced by increasing the number of the chains of phonemes (tracks) in each of the EVS generating apparatuses.

Further the more the number of the EVS generating apparatus to be disposed in the object space, the more directivity or directionality of the listeners with respect to the environmental sound can be weakened, and hence a state closer to a psychological silent state for the listeners can be formed. This is because if all the phonemes of the primary pitch group are listened simultaneously from a single EVS generating apparatus, this sound may be recognized as a dissonance, whilst all the phonemes of the primary pitch group sounded simultaneously fromplural (e.g., three) directions are unlikely or hardly recognized as a dissonance. Consequently, the EVS generating apparatuses arranged in the aforesaid manner can generate the environmental sound that can cancel other person's talk and noise, etc. unnecessary for remaining persons to create a quiet state and/or relieve tension to bring a mentally gentle state, without separating many people into those who likes and feel pleasure of the sound and those who do not like or feel pleasure of the sound.

Accordingly in a conference room, a lecture room, a seminar room, etc., speech of a lecturer or the like can be listened clearly for listeners despite of ambient noise such as noise from an air conditioner, and hence listeners' concentration on the lecture, etc. can be enhanced.

The number of the tracks of each of the EVS generating apparatuses 1 and the number of the EVS generating apparatuses 1 are not limited to the aforesaid example, but may be set optionally. Preferably the number of the EVS generating apparatuses 1 is at least three and the number of the tracks of each of the EVS generating apparatuses 1 is at least one under a condition that the total number of the tracks of the EVS generating system 100 is twelve or more.

Although FIGS. 3B to 3E show individual examples of four environmental sounds, each constituted of four chains of phonemes (four tracks), emitted from the four EVS generating apparatuses (Generators A, B, C and D), respectively, the environmental sound each constituted of three chains of phonemes (three tracks) is emitted in the similar manner from each of the four EVS generating apparatuses 1A to 1D in the second embodiment.

### Third Embodiment

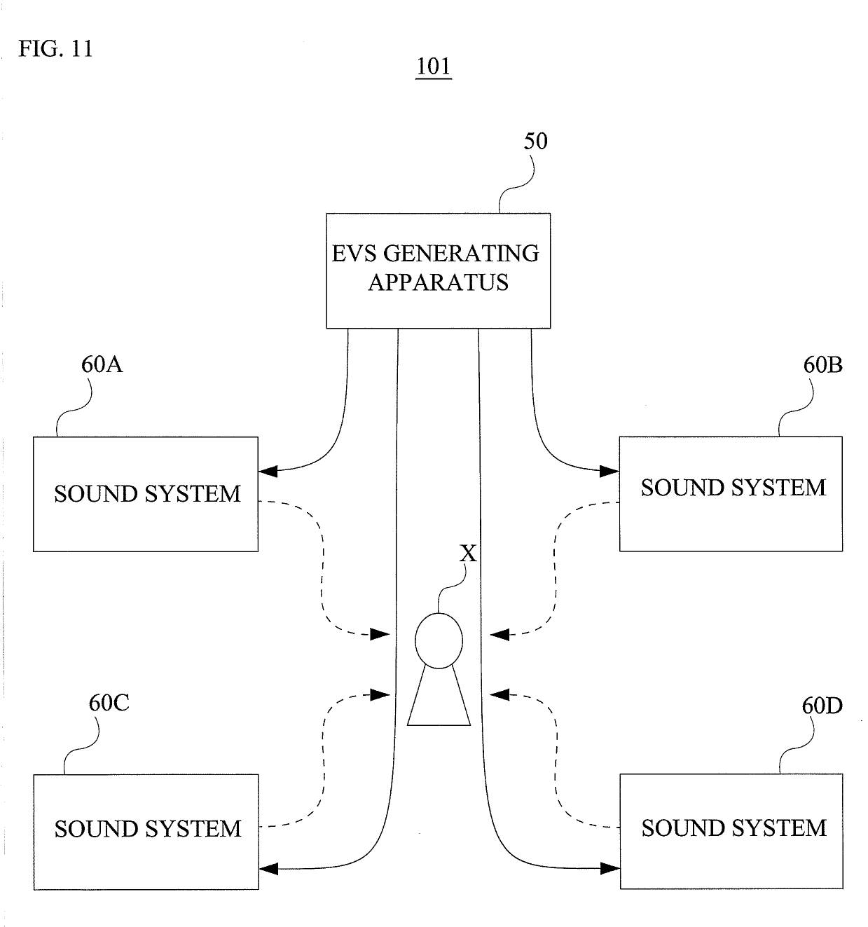

FIG. 11 is a schematic block diagram illustrating an EVS generating system 101 according to a third embodiment of the present invention as a modified example of the second embodiment. In this embodiment, the EVS generating system 101 is constituted of a single EVS generating apparatus 50 and a plurality of satellite devices 60 (e.g., four satellite devices 60A, 60B, 60C, 60D) arranged in a predetermined object space. The EVS generating apparatus 50 generates an environmental sound signal for an environmental sound to be emitted from each of the four satellite devices 60, then multiplexes all these environmental sound signals and transmits the multiplexed environmental sound signal toward the four satellite devices 60. Each of the four satellite devices 60 receives the multiplexed environmental sound signal, then separates and extracts own environmental sound signal and emits own environmental sound (see broken lines in FIG. 11).

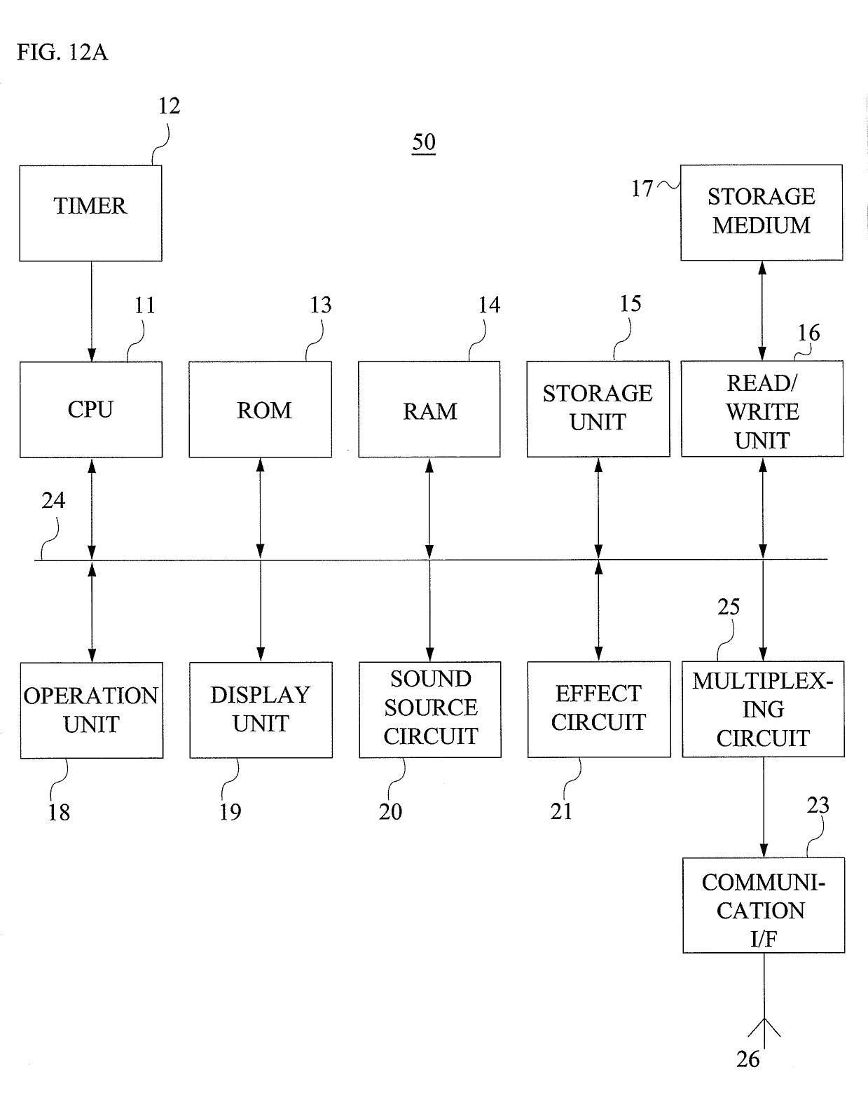

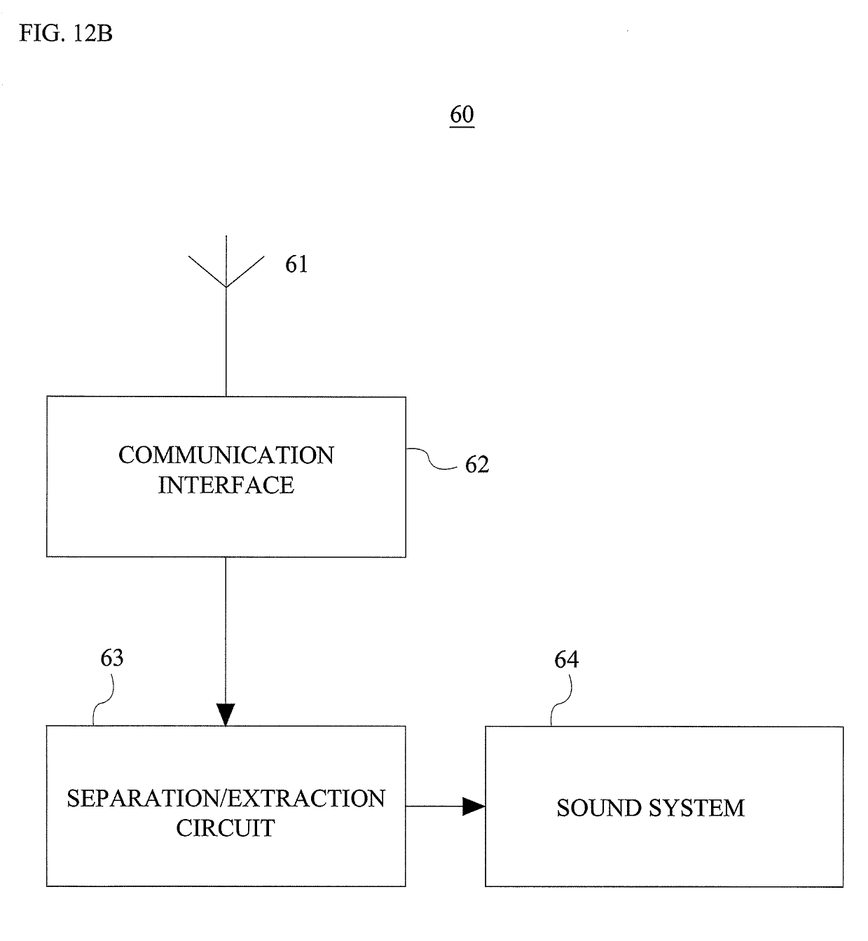

FIG. 12A is a schematic block diagram illustrating an example of the EVS generating apparatus 50 and FIG. 12B is a schematic block diagram illustrating an example of each of the satellite devices 60. In FIGS. 12A and 12B, portions identical or similar to those of FIG. 4 in their functions and/or configurations are referred to by the common symbols, with explanation thereof being omitted.

The EVS generating apparatus 50 of FIG. 12A differs from the EVS generating apparatus 1 of FIG. 4 in a point that the sound system 22 is not provided but a multiplexing circuit 25 and an antenna 26 are provided. In this embodiment, the EVS generating apparatus 50 generates individual environmental sound signals for environmental sounds to be emitted from the four satellite devices 60A to 60D using the sound source circuit 20, the effect circuit 21, etc., like the first embodiment, then multiplexes these environmental sound signals using the multiplexing circuit 25 according to the known multiplexing method (e.g., space-division multiplexing (SDM), frequency-division multiplexing (FDM), time-division multiplexing (TDM), code division multiplexing (CDM) or the like), and transmits the multiplexed environmental sound signal via the communication interface 23 and the antenna 26 (see steady lines in FIG. 11). The method of generating the environmental sound in each of the satellite devices 60A to 60D may be same as that of the first embodiment. Each of the satellite devices 60A to 60D generates own environmental sound independently.

As shown in FIG. 12B, each of the satellite devices 60A to 60D includes an antenna 61, a communication interface 62, a separation/extraction circuit 63 and a sound system (having a D/A converter, a speaker, etc.) 64. Each of the satellite devices 60 A to 60D receives the multiplexed environmental sound signal, then separates and extracts own environmental sound signal, and reproduces and emits own environmental sound from the sound system 64. The communication interface 62 and the sound system 64 correspond to the communication interface 63 and the sound system 22 of FIG. 4, respectively.

The environmental sound generating system thus configured can achieve the substantially same effect as the environmental sound generating system of the second embodiment.

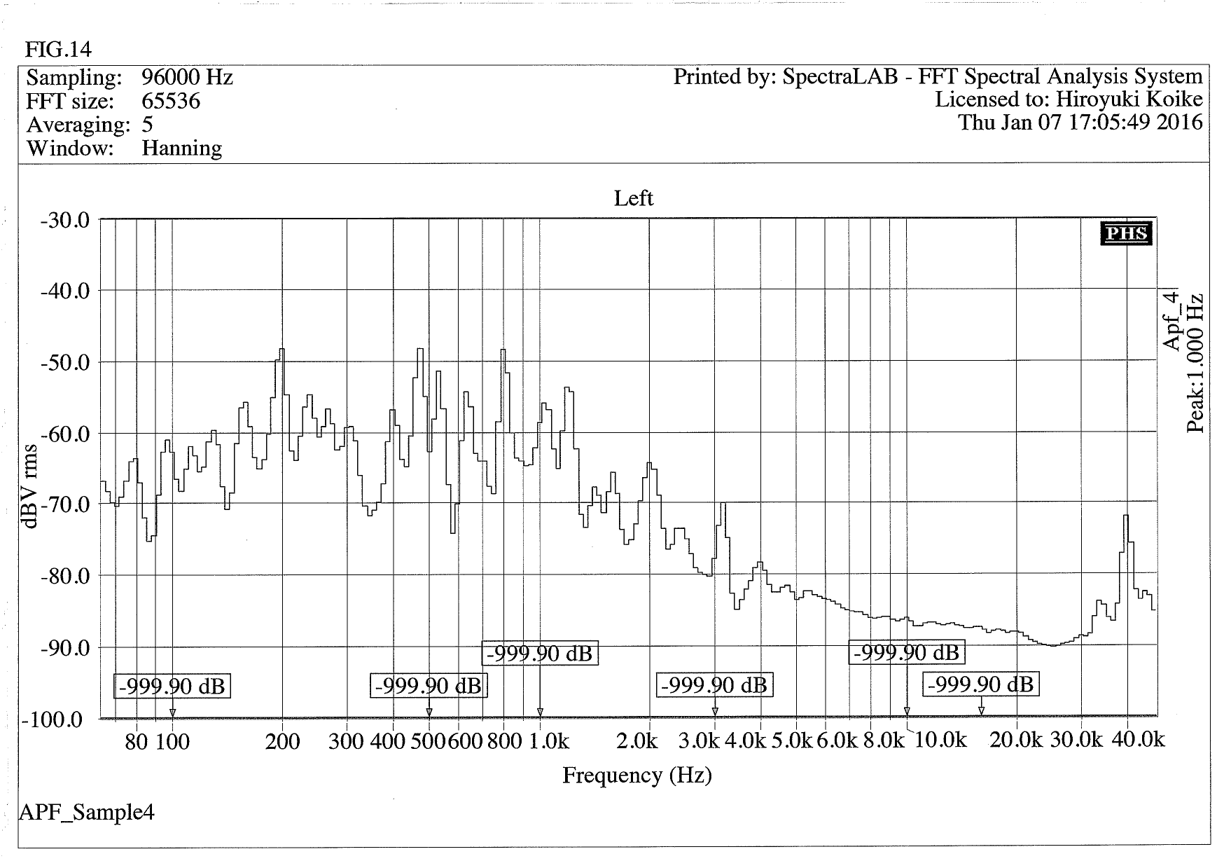

Hereinafter advantageous effects of the above-described embodiments will be explained with reference to experimental results shown in FIGS. 14 to 20. In general, a human audible frequency range is about 20 to 20,000 Hz, and a sound of 8,000 Hz or more is considered to activate human's brain and be high in healing effects. Classical music generally considered to have healing effects, in particular, Mozart's music contains much high-frequency components of 8,000 Hz or more. In particular, a sound of around 50,000 to 80,000 Hz is considered to impart clear feeling to listeners and attain hypersonic effects.

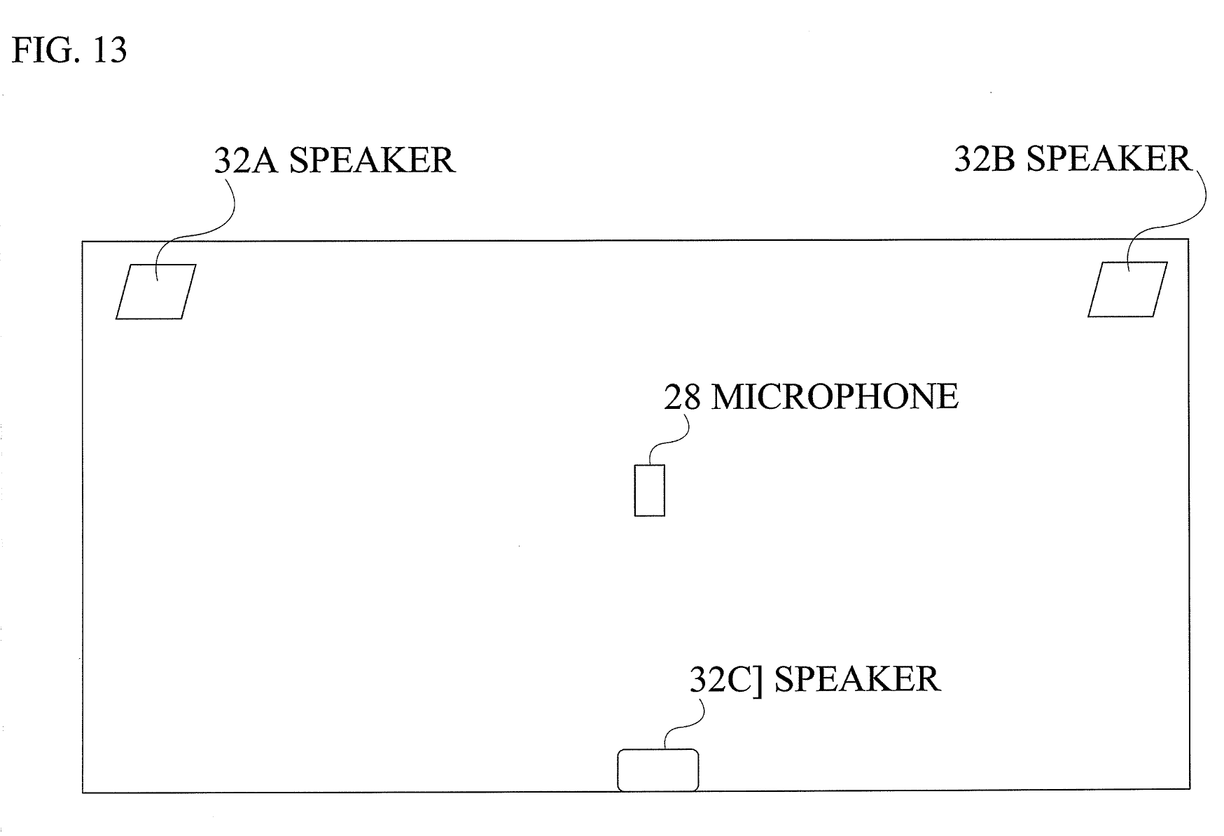

In the experiments, as shown in FIG. 13, speakers 32A and 32B are respectively disposed at left and right corners of a front side wall of a square or rectangular object space (room, office or the like), a speaker 32C is disposed at the center portion of a rear side wall, and a microphone 28 for detecting sounds transmitted from these speakers is disposed almost at the center of the square or rectangular object space. Sounds detected by the microphone 28 are measured by a not-shown measuring device.

The measurement results of the measuring device described below was obtained using Spectra LAB Ver. 4.32 of Pioneer Hill Software LLC as measurement software, Fireface UC of RME as a measurement AD/DA converter, and Earthworks TC −40K as a measurement microphone. The measurement was performed at a sampling rate of 96 kHz and the measurement results was subjected to the simple moving average of five samples. Further, for example, the fast Fourier transformation was performed by dividing the measured frequency range of 0 to 48 kHz into 65,536 sections.

FIG. 14 shows typical measurement results of the frequency characteristics in a case of emitting a typical classical music played by a piano from the speaker 32A.

As clear from FIG. 14, a sound pressure level was relatively high over a range from about 150 to 8,000 Hz because pitches of the music and harmonics thereof were measured as they were. In contrast, a sound pressure level was low in a high-frequency range of about 10,000 Hz or more.

In this manner, in general, a sufficient sound pressure level cannot be obtained in the high-frequency range of about 10,000 Hz or more in a case playing classical music by a piano, and hence the hypersonic effects cannot be attained.

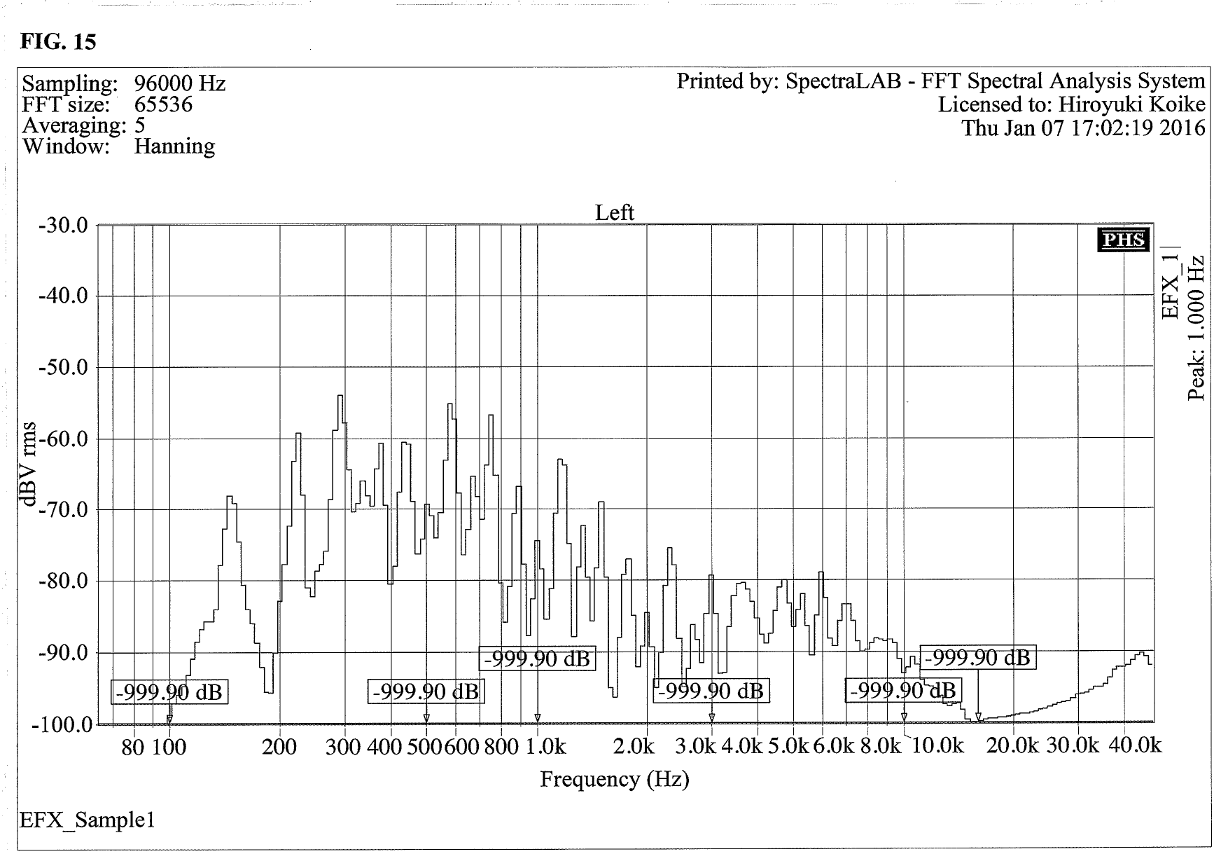

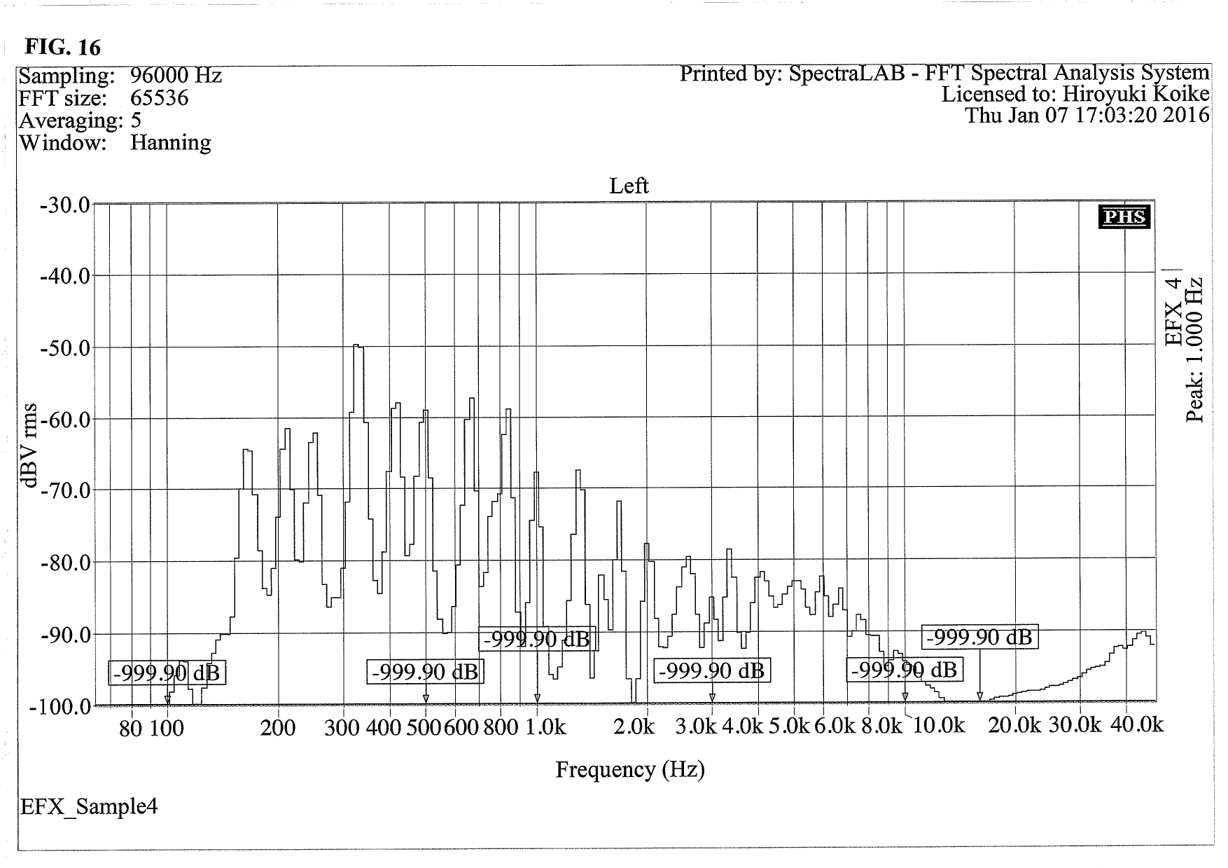

Next, FIGS. 15 and 16 show one and another examples of typical measurement results of the frequency characteristics of the environmental sounds generated from the EVS generating apparatuses according to the second and third embodiments, respectively.

Each of FIGS. 15 and 16 shows the measurement result obtained by directly extracting the environmental sounds, generated by the three EVS generating apparatuses according to the second or third embodiment, from LINE outputs without emitting from the speakers. In these examples, each of the EVS generating apparatuses generated the environmental sound of four tracks.

Unlike the harmonics effects subsidiarily attained in a case of generating music composed by the known automatic composition system, as clear from FIGS. 15 and 16, the environmental sound generated by the EVS generating apparatuses according to the second or third embodiment could always obtain sufficient sound pressure level in a high-frequency range, particularly, in a frequency range from 20,000 to 80,000 Hz due to the effect of harmonics such as second harmonic, and hence the hypersonic effects can be attained.

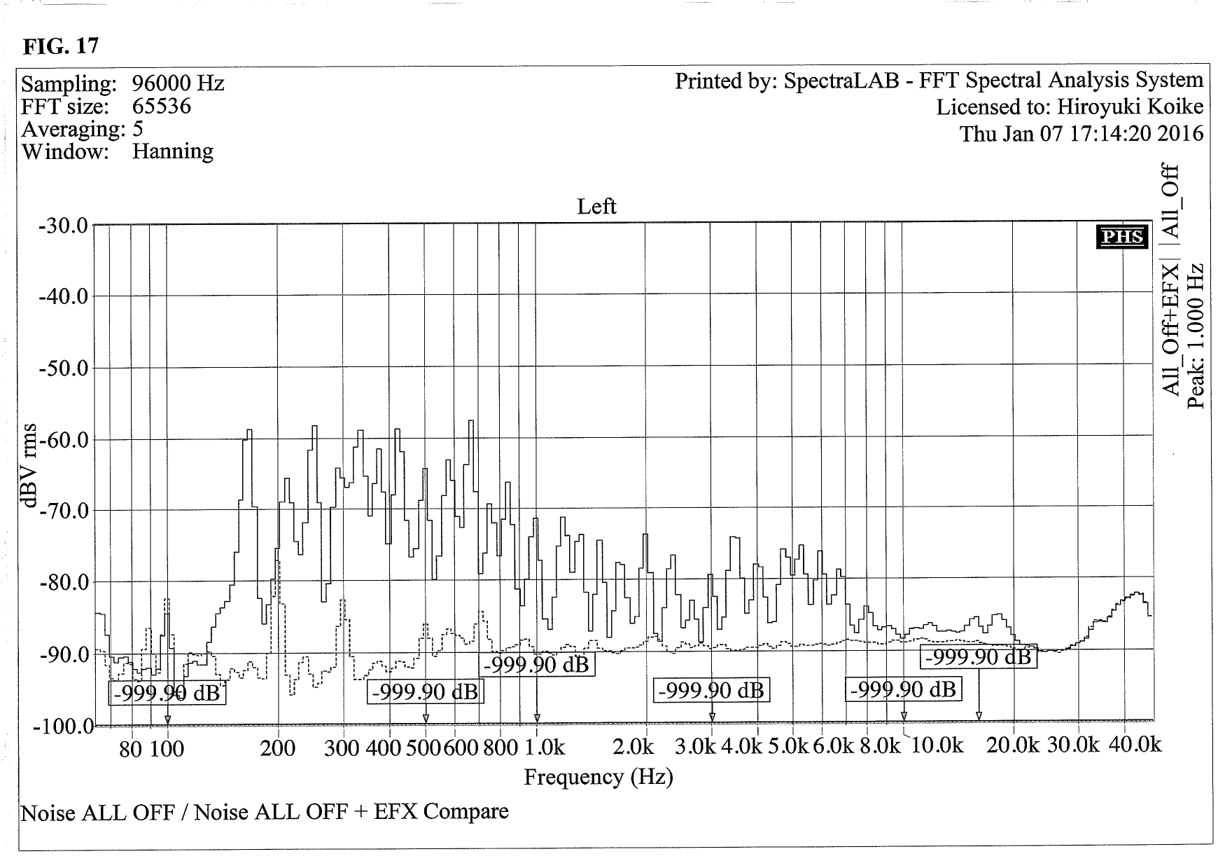

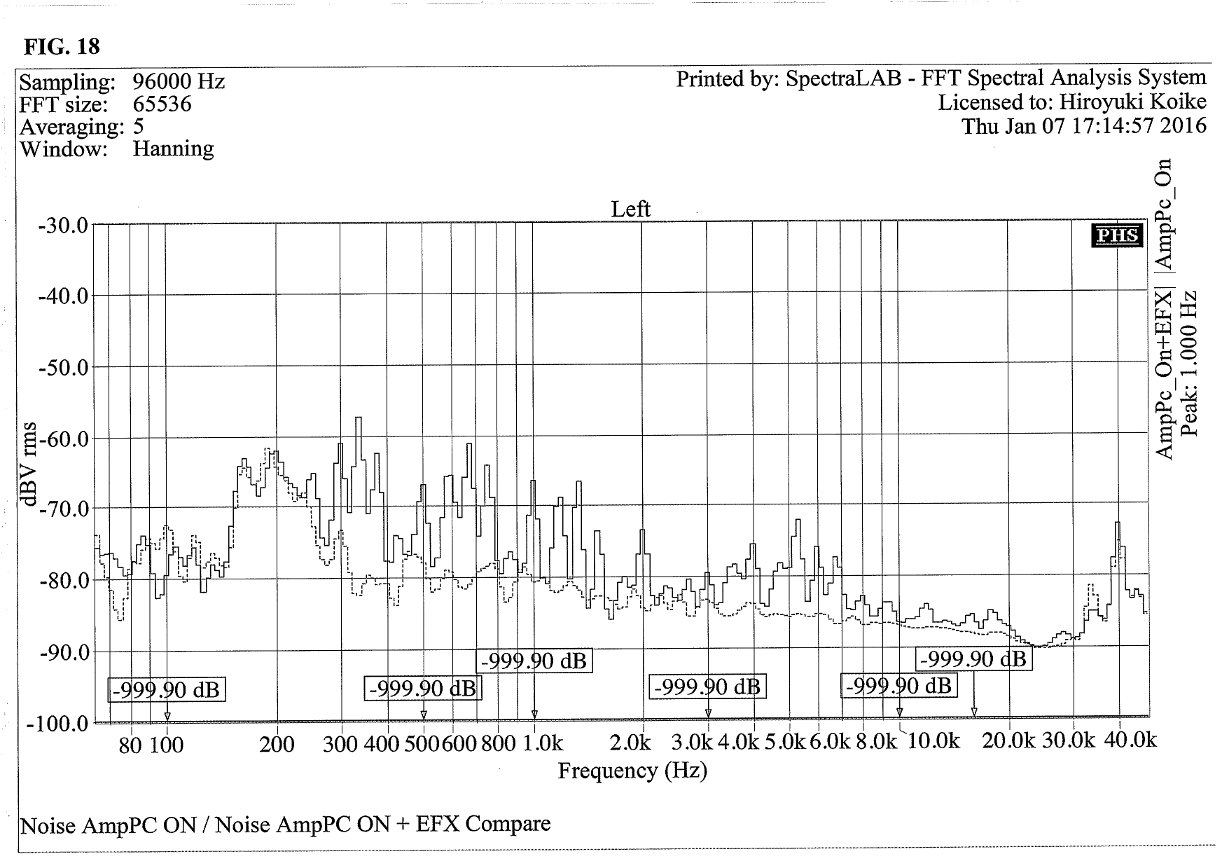

Next, FIGS. 17 and 18 show examples of typical measurement results of the frequency characteristics of the environmental sounds generated from the EVS generating apparatus according to the second or third embodiment and examples of typical measurement results of the frequency characteristics of noise, in a usual room such as an office or a conference room.

Each of FIGS. 17 and 18 shows the measurement result obtained by measuring the environmental sounds generated by the three EVS generating apparatuses according to the second or third embodiment and emitted from the three speakers corresponding to the respective EVS generating apparatuses. In these examples, each of the EVS generating apparatuses generated the environmental sound of four tracks.

The measurement results shown in each of FIGS. 17 and 18 was obtained in a typical room provided with an air conditioner, a TV and a personal computer. The measurement results shown in FIG. 17 was obtained in a state where all of the air conditioner, TV and personal computer are turned off and the environmental sounds generated by the three EVS generating apparatuses are emitted from the three speakers. In this figure, a broken lines denotes the measurement results of noise, whilst a steady line denotes the measurement results of the environmental sounds.

In the case of FIG. 17, as a sound pressure level of the noise was low over the entire frequency range as shown by the broken line, a sound pressure level of the environmental sounds was distinct as compared with the noise over the entire frequency range. It is notable that the sound pressure level of the environmental sounds was distinct as compared with the noise in a high-frequency range of 50,000 to 100,000 Hz.

In this manner, in such the usual room environment, as the sound pressure level of the environmental sounds was distinct as compared with the noise over the entire frequency range, persons within the room cannot hear and hence do not notice or care of the noise. Further as the sound pressure level of the environmental sounds was sufficiently high as compared with the noise in a frequency range of 20,000 to 80,000 Hz, the hypersonic effects can be attained.

The measurement results shown in FIG. 18 was obtained in a state where the air conditioner is on, the TV is in a and the personal computer is off but only its monitor is on, and the environmental sounds generated by the three EVS generating apparatuses are emitted from the three speakers. In this figure, a broken lines denotes the measurement results of noise, whilst a steady line denotes the measurement results of the environmental sounds.

In this respect, the TV emitted noise around 200,000 Hz exceeding the human's audible frequency even in the power-saving mode. The sound pressure level of the noise emitted from the monitor of the personal computer was high at a frequency of about 200 Hz, whilst the sound pressure level of the noise emitted from the air conditioner was high at a frequency of about 100 Hz. The largest sound pressure level was about −60 to −70 dB of the personal computer. Thus the total sound pressure level of the noise within the room is shown by the broken line in FIG. 18.

The merged environmental sound generated by the three EVS generating apparatuses had a waveform of the sound pressure level similar to that of the noise in a range of about 20 to 2,000 Hz, but had a waveform of the sound pressure level larger than the noise in a frequency range of about 300 Hz or more.

Thus in such the room environment, also as the sound pressure level of the environmental sounds was distinct as compared with the noise almost over the entire frequency range, persons within the room cannot hear and hence do not notice or care of the noise. In particular, as the sound pressure level of the environmental sounds was sufficiently high as compared with the noise in a high frequency range of 50,000 to 100,000 Hz, the hypersonic effects can be attained like the case of FIG. 17.

Further as the sound pressure level of the environmental sounds was sufficiently high as compared with noise such as human voices as well as the aforesaid cases almost over the entire frequency range, the similar effects can be achieved.

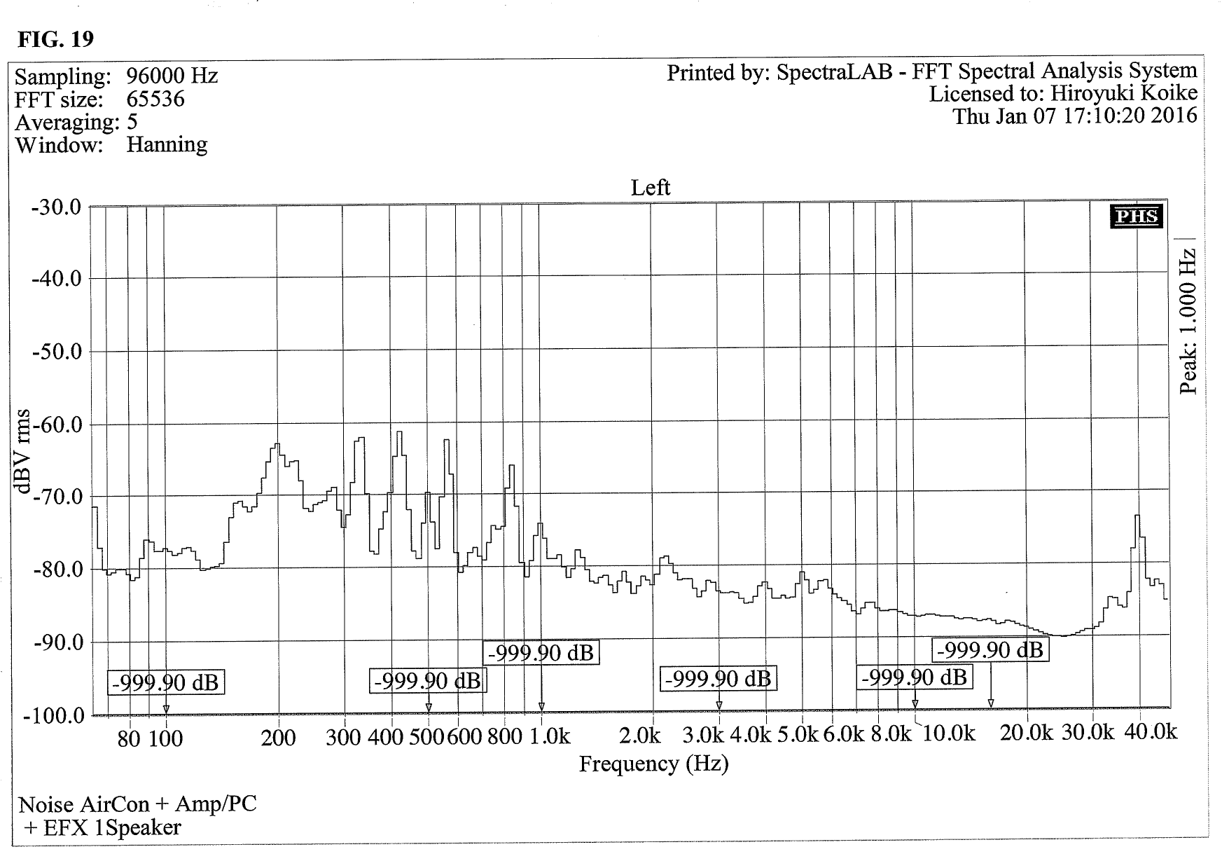

Next, FIG. 19 shows an example of typical measurement results of the frequency characteristics of the environmental sound generated from one of the EVS generating apparatuses according to the second or third embodiment and emitted from the speaker 32A.

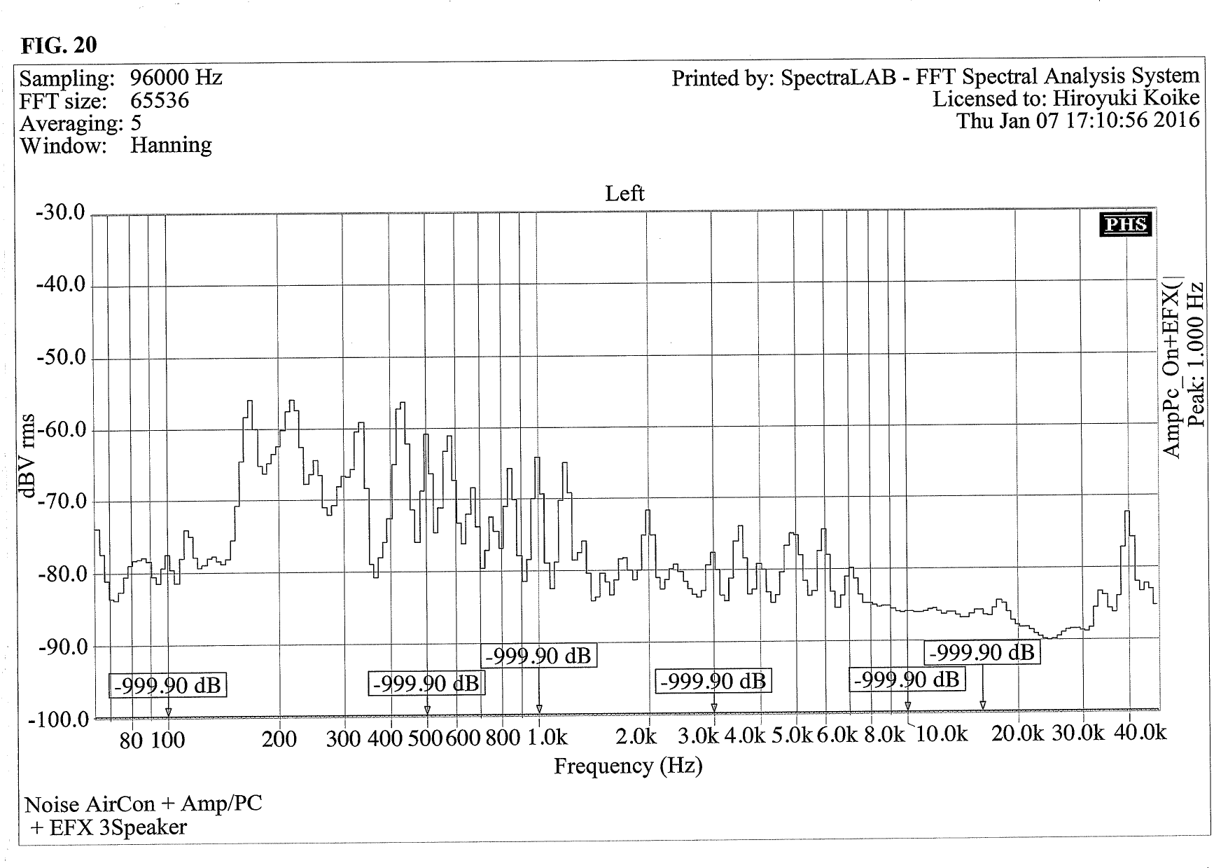

FIG. 20 shows an example of typical measurement results of the frequency characteristics of the environmental sounds generated by the three EVS generating apparatuses according to the second or third embodiment and emitted from the three speakers corresponding to the respective EVS generating apparatuses. In these examples shown in FIGS. 19 and 20, each of the EVS generating apparatuses generated the environmental sound of four tracks.

As clear by comparing FIGS. 19 and 20, the sound pressure level of the merged environmental sounds generated from the three EVS generating apparatuses was larger than that of the environmental sound generated from the single EVS generating apparatus over the entire frequency range, in particular, in a frequency range of about 200 Hz where the noise from the personal computer is emitted and also in a high-frequency range of 10,000 Hz or more. Thus it will be clear that the hypersonic effects can be achieved more effectively in the case of using a plurality of, preferably, three or more EVS generating apparatuses as compared with the case of using the single EVS generating apparatus.

According to the experimental results explained above, even in a large space or room (for example, a waiting room and a consulting room of a hospital, an office, a lecture room, a conference room, a library, a tearoom, and so on), as the sound pressure level of the environmental sound(s) generated from the EVS generating apparatus(es) is larger than that of the space noise substantially over the entire frequency range, persons within the space cannot hear and hence do not notice or care of the noise. Consequently the EVS generating apparatus and the EVS generating system according to the aforesaid embodiments can generate the environmental sound (specifically, the environmental sound signal representing environmental sound) that can cancel other person's talk and noise, etc. unnecessary for remaining persons to create a quiet state and/or relieve tension to bring a mentally gentle state, without separating many people within the space into those who likes and feel pleasure of the sound and those who do not like or feel pleasure of the sound. Further, as the sound pressure level of the environmental sounds is sufficiently high as compared with the space noise also in a frequency range of 20,000 to 80,000 Hz, the hypersonic effects can be attained.

### Fourth Embodiment

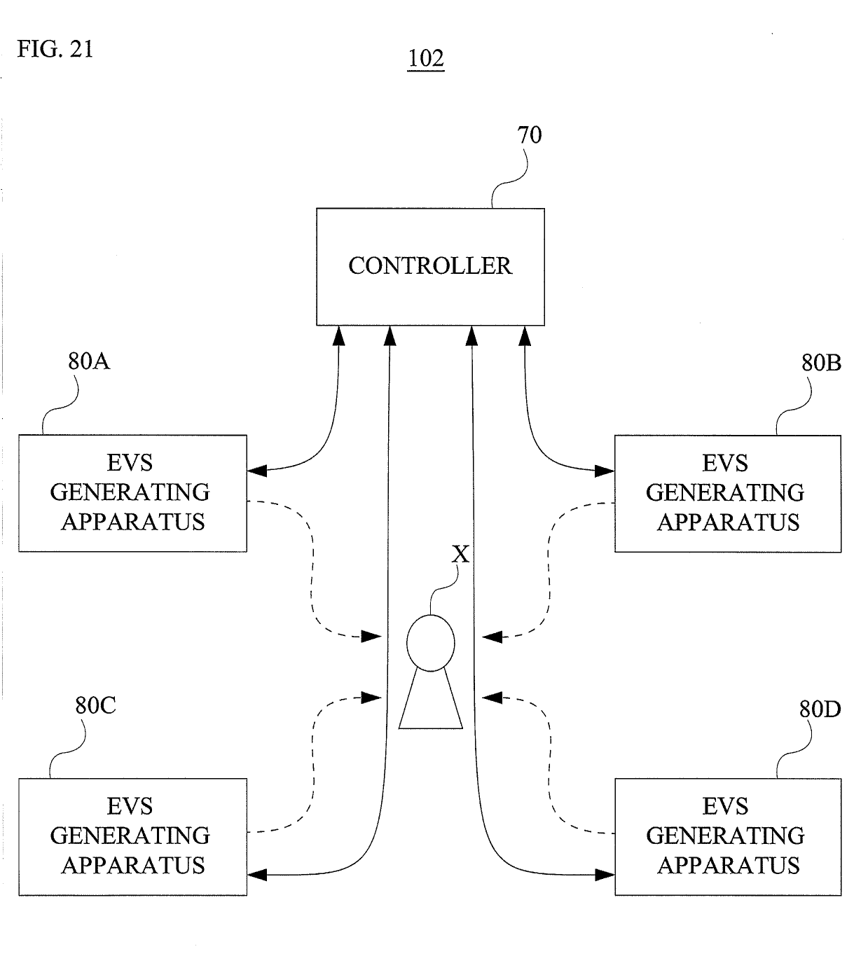

Next an EVS generating system 102 according to a fourth embodiment of the invention will be explained with reference to FIG. 21.

In general, avolume level attenuate in proportion to adistance from a sounding body. According to the EVS theory, in place of filling an object space by the environmental sounds, it is intended to attain effects similar to the case of filling the environmental sound by setting, at each position of individual persons in the space, a volume of the environmental sound to, at the maximum, almost the same as a volume of sound other than the environmental sound listened by the individual persons in the space. In order to realize this, it is necessary to install plural sounding bodies (EVS generating apparatuses or satellite devices) in the space and control volumes of the environmental sounds listened by the individual persons. Further, as sound environment changes with time, it is necessary to automatically change the environmental sounds according to the sound environment.

In order to satisfy such the requirement, it may seem to be sufficient to simply impart functions satisfying such the requirement to each of the EVS generating apparatuses. However as each people has directivity or directionality as to recognition of a sound, if the functions satisfying such the requirement is simply imparted to each of the EVS generating apparatuses, the person may recognize the directivity or directionality of the environmental sound and hence notice the environmental sound. In order to avoid such a situation, it is necessary to totally control the individual EVS generating apparatuses based on data collected from the EVS generating apparatuses. The EVS generating system according to the fourth embodiment is configured in order to realize such the requirement.

More specifically, persons' voices, noise, etc. other than the environmental sounds emitted from the sounding bodies (EVS generating apparatuses, etc.) are detected and the environmental sound(s) to be emitted from at least one of the sounding bodies (EVS generating apparatuses, etc.) is controlled so as to cancel the voices, noise, etc. Further as the human body absorbs sounds of a low-frequency range, the environmental sound(s) of the low-frequency range is absorbed by persons in the object space. Thus it is necessaryto suitably increase avolume of the environmental sound(s) of the low-frequency range. In order to perform such the control automatically, each of the EVS generating apparatuses (satellite devices) is provided with a microphone (sound detection means) and a camera (imaging device or image detection means (imaging means)), as individual units for detecting environmental information (i.e., environmental information acquisition means), for example. A controller analyzes the number or capacity, etc. of persons in the space based on image data obtained from the cameras, analyzes actual sound signals obtained from the microphones, and transmits control signals for controlling the sound systems (equalizer, etc.) of the EVS generating apparatuses (satellite devices) thereto. As persons move often, the controller totally determines the data from the EVS generating apparatuses (satellite devices) and transmits the control signal to the EVS generating apparatus (satellite device) expected to change its control according to the persons' movement.

In order to effectively maintain the sound environment based on the environmental sound, it is demanded to physically eliminate or cancel other person's talk and noise, etc. unnecessary for remaining persons.

To this end, it is necessary to suitably set a balance of a volume of the environmental sound with respect to the sound and noise to be eliminated or cancelled. Further, as the sound in the space changes its travelling direction due to an obstacle and hence its phase and volume are changed. Thus, preferably, the controller detects and analyzes these changes based on the detection signals from the EVS generating apparatuses (satellite devices) and transmits the control signal in response thereto to the EVS generating apparatuses (satellite devices), if necessary.

The entire configuration of the EVS generating system 102 according to this embodiment will be explained with reference to FIG. 21. The EVS generating system 102 according to this embodiment includes the controller 70 and a plurality of the EVS generating apparatuses (satellite devices) 80, e.g., four EVS generating apparatuses (satellite devices) 80A, 80B, 80C, 80D.

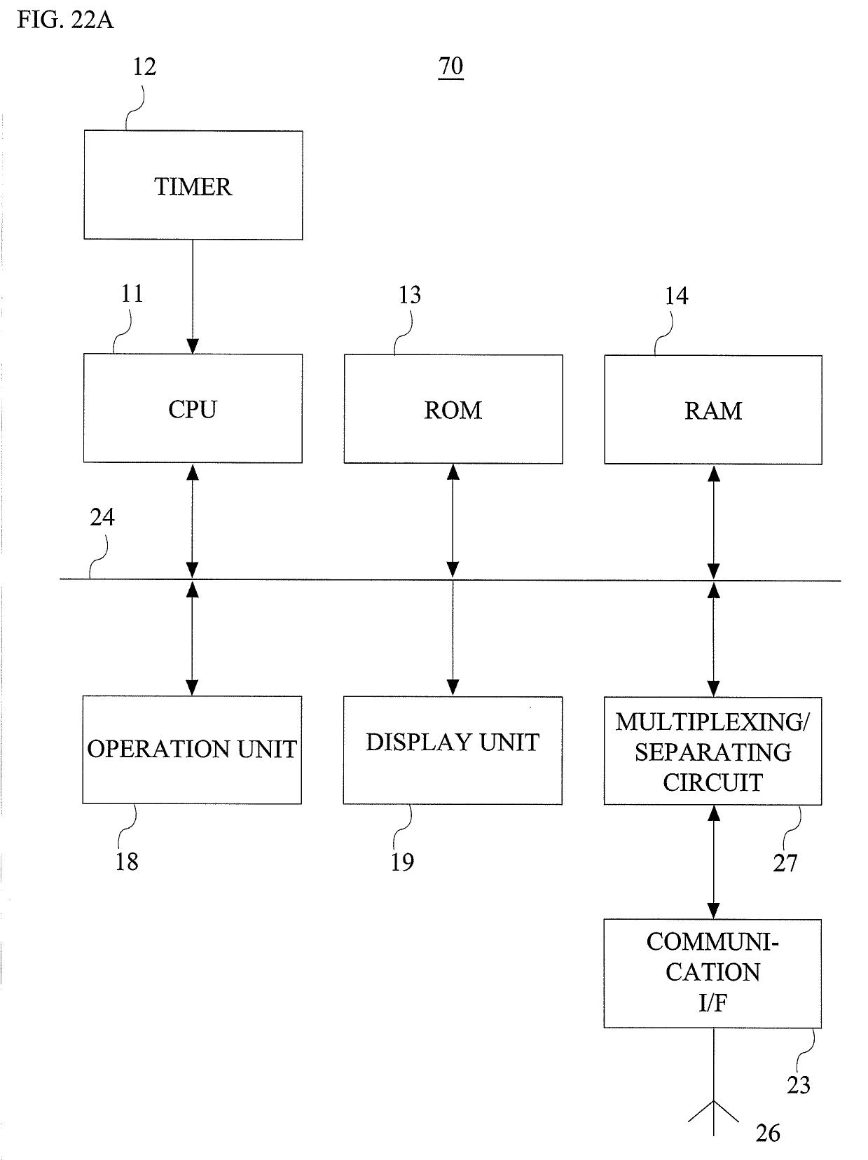

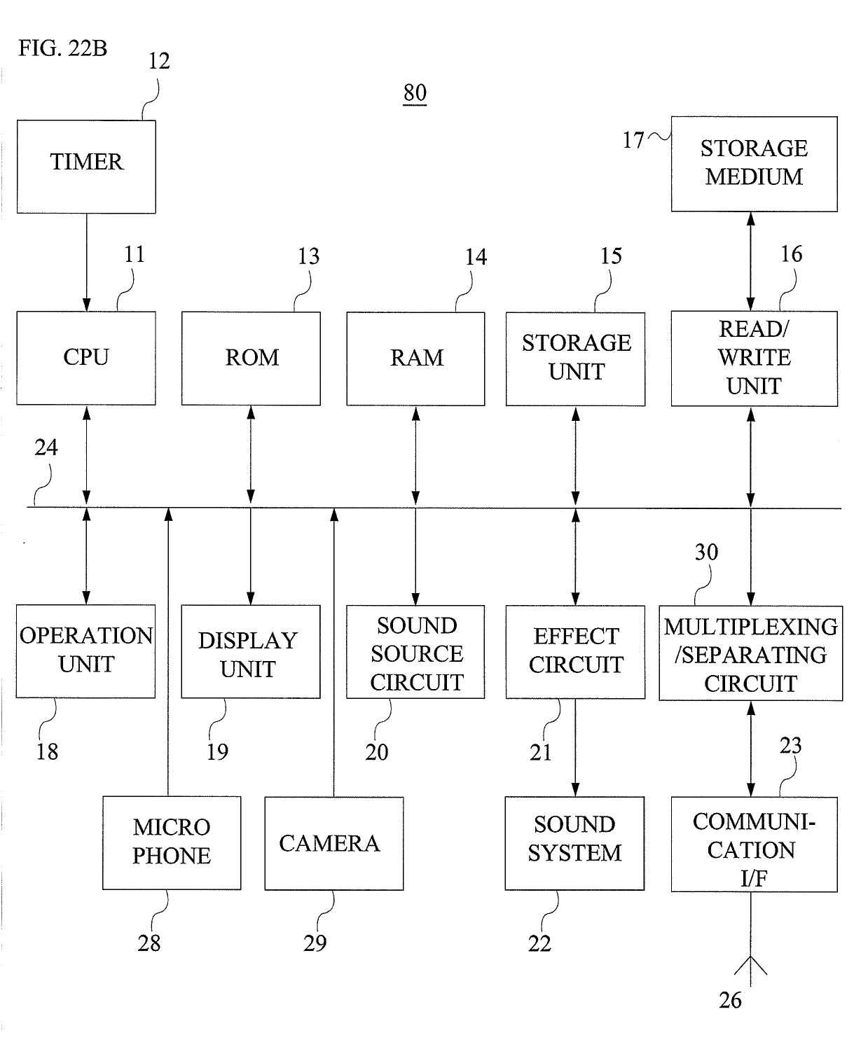

FIG. 22A shows an example of the schematic configuration of the controller 70 and FIG. 22B shows an example of the schematic configuration of each of the EVS generating apparatuses 80A, 80B, 80C, 80D. In FIGS. 22A and 22B, portions identical or similar to those of FIG. 4 in their functions and/or configurations are referred to by the common symbols, with explanation thereof being omitted. The controller 70 is configured by a general personal computer as a hardware and includes a CPU 11, a timer 12, an ROM 13, an RAM 14, an operation unit 18 such as a keyboard or a mouse, a display unit 19 such as an LCD panel, a multiplexing/separating circuit 27, a bus 24 mutually connecting these constituent elements and a communication interface 23.

Each of the EVS generating apparatuses (satellite devices) 80 is configured to further include a microphone 28 connected to the bus 24, a camera (imaging device) 29 and a multiplexing/separating circuit 30, in addition to the configuration of the EVS generating apparatus 50 shown in FIG. 12A.

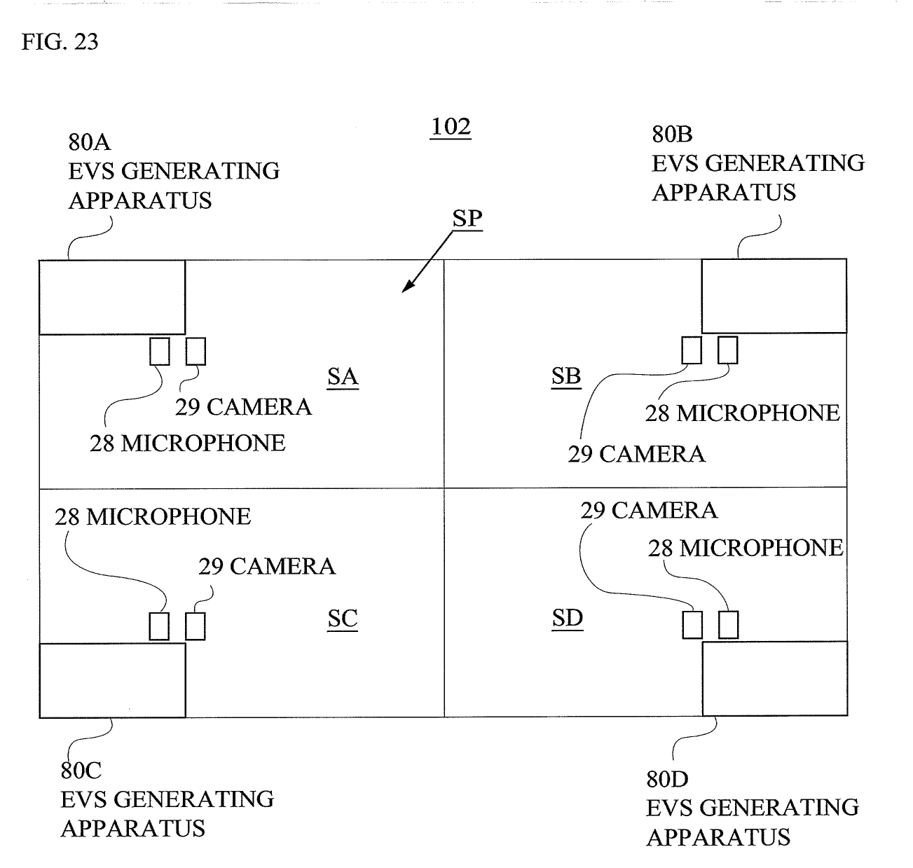

FIG. 23 is a schematic diagram illustrating an example of the arrangement of the microphones 28 and the cameras 29 in the EVS generating system 102 of FIG. 21. For example, in a case of arranging the four EVS generating apparatuses 80A, 80B, 80C, 80D at four corners of a square or rectangular object space SP, the EVS generating apparatuses 80A to 80D respectively collect sound data and image data detected by the corresponding microphones 28 and cameras 29 from associated object spaces SA, SB, SC, SD obtained by dividing the object space SP into substantially four sections. Of course, the number of the camera and the microphone provided in each of the object spaces SA, SB, SC, SD is not limited to one but a plurality of the cameras and microphones may be provided for each of the object spaces. In this case, each of the EVS generating apparatuses may collectively process the detection signals from the plural cameras andmicrophones and transmit the processed signals to the controller 70.

Next an operation of the EVS generating system 102 of FIGS. 22A and 22B will be explained.

In the EVS generating apparatus 80 shown in FIG. 22B, the CPU 11 periodically samples a digital sound detection signal representing sound in the associated object space detected by the associated microphone and a digital image detection signal representing an image in the associated object space detected by the associated camera, then multiplexed by the multiplexing/separating circuit 30 and transmitted periodically to the controller 70 via the communication interface 23 and the antenna 26. The multiplexing method of the multiplexing/separating circuit 30 may be same as that of the multiplexing circuit 25. Of course, the digital sound detection signal and the digital image detection signal may be transmitted independently without being multiplexed.

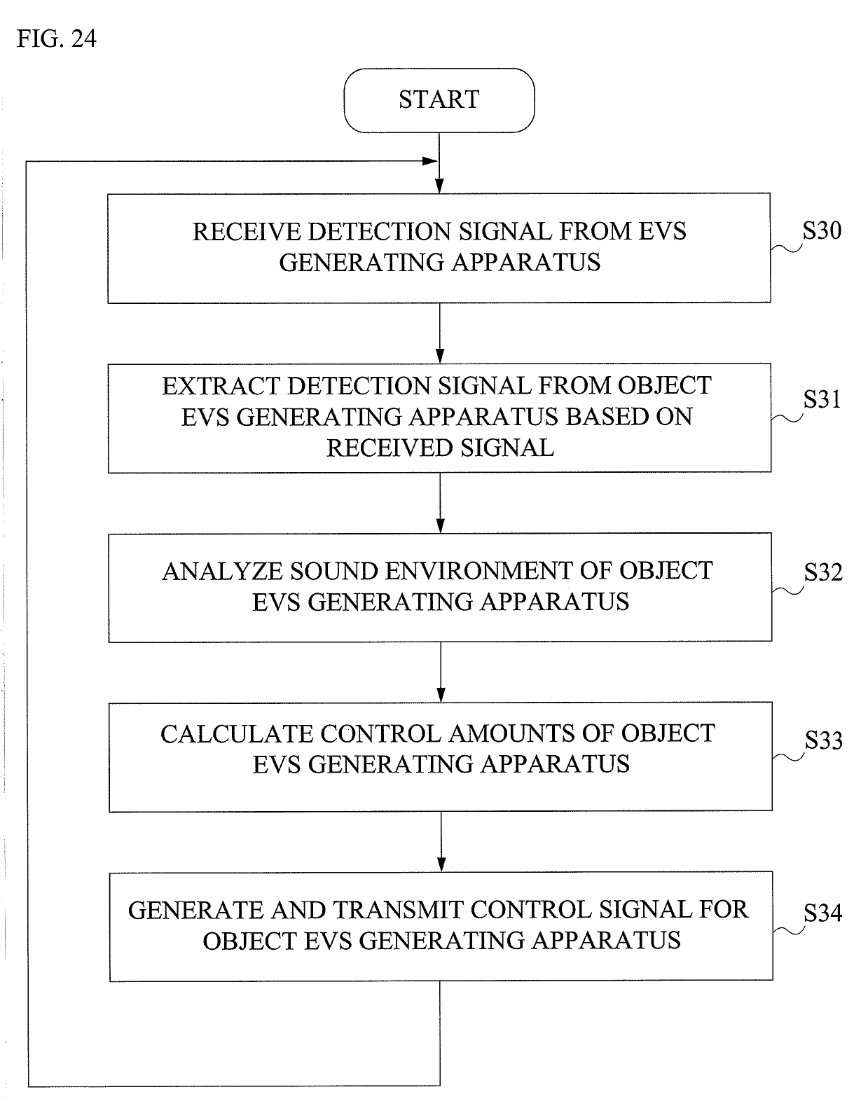

An example of an operation of the controller 70 of FIG. 22B according to this embodiment will be explained with reference to a flowchart shown in FIG. 24.

The controller 70 receives the detection signals transmitted from each of the EVS generating apparatuses 80 via the antenna 26 and the communication interface 23 (step S30) and the multiplexing/separating circuit 27 separates and extracts the individual detection signals for each of the EVS generating apparatuses 80 (step S31). In order to perform this separation/extraction operation, such a known method of making transfer frequencies of the detection signals differ to each other for each of the EVS generating apparatuses 80 may be employed. Alternatively, an identification data or the like may be added to each of the detection signals from the EVS generating apparatuses 80. Then the CPU 11 analyzes the sound environment of each of the object spaces SA, SB, SC, SD of the EVS generating apparatuses 80 based on the associated detection signals (step S32), calculates a control amount of the volume level for each of the EVS generating apparatuses 80 (step S33) and transmits as a control signal via the communication interface 23 and the antenna 26 (step S34).

The CPU 11 may execute these steps S30 to S34 continuously for each of the EVS generating apparatuses 80 one by one with a predetermined interval. Alternatively, for example, the detection signals from all the EVS generating apparatuses 80 may be stored in a buffer memory in step S30, and the processing of step S31 to S34 may be performed continuously for each of the EVS generating apparatuses 80 one by one, or each processing of step S31 to S34 may be performed for each of the EVS generating apparatuses 80 in a sequential manner.

Volume level control based on the sound detection signal will be explained.

In a case where the sound detection signal from the EVS generating apparatus 80A, for example, contains a sound (noise, human voices, etc.) of a volume level equal to or larger than the environmental sound emitted from the EVS generating apparatus 80A, the controller 70 transmits the control signal for the EVS generating apparatus 80A so as to increase the volume level of the environmental sound at a frequency range corresponding to that of the detected sound to the detected volume level.

As an example, the controller 70 may generate the control signals for the individual EVS generating apparatuses 80 separately, then multiplex the control signals by the multiplexing/separating circuit 27 and transmit to the EVS generating apparatuses 80 via the communication interface 23 and the antenna 26. The multiplexing method of the multiplexing/separating circuit 27 may be same as that of the multiplexing circuit 25. Of course, the control signals for the individual EVS generating apparatuses 80 may be transmitted independently without being multiplexed.

The volume control may be performed in a manner, for example, of extracting a frequency pattern of the detected volume level based on the sound detection signal from the EVS generating apparatus, comparing the extracted frequency pattern with a frequency pattern of the volume level of the environmental sound as a reference pattern, then preparing the control signal so that the frequency pattern of the volume level in the associated object space coincides with the frequency pattern of the volume level of the environmental sound.

The EVS generating apparatus 80A of FIG. 22B receives the control signal from the controller 70 via the antenna 26 and the communication interface 23 and extracts the control signal for the EVS generating apparatus 80A by the multiplexing/separating circuit 27. The CPU 11 controls the sound system 22 (equalizer, etc.) according to the extracted control signal so as to control the volume of the environmental sound of the corresponding frequency range.

Concerning the tone quality and phase of the detected sound, in a similar manner, the controller 70 detects a change of tone quality and phase of the detected sound based on the sound detection signal from the EVS generating apparatus 80A, then generates a control signal for subjecting the environmental sound for the EVS generating apparatus 80A to feedback control based on the detected change and transmits via the communication interface 23 and the antenna 26. The EVS generating apparatus 80A controls the sound system 22 according to the control signal so as to perform feedback-control of the tone quality and phase of the environmental sound.

The aforesaid control is performed in the similar manner as to each of the EVS generating apparatuses 80B, 80C, 80D.

Next, the control processing based on the image detection signal will be explained.

The controller 70 analyzes the number of persons and movements of the persons using a known image analysis/recognition method (e.g., pattern matching method) based on the image detection signal from the EVS generating apparatus 80A, for example. As an example, the controller 70 generates and transmits a control signal for increasing a volume level of a low-frequency range of the environmental sound to be emitted from the EVS generating apparatus 80A, according to the number of persons.

The EVS generating apparatus 80A receives the control signal from the controller 70 via the antenna 26 and the communication interface 23, then extracts the control signal for the EVS generating apparatus 80A by the multiplexing/separating circuit 27. The CPU 11 controls the sound system 22 (equalizer, etc.) according to the extracted control signal so as to increase volume level of a low-frequency range of the environmental sound to be emitted from the EVS generating apparatus 80A.

Further the controller 70 may analyze the moving direction of persons and generate and transmit a control signal for increasing a volume level of a low-frequency range of the environmental sound of the EVS generating apparatus associated with the object space to which the persons move.

The aforesaid control is performed in the similar manner as to each of the EVS generating apparatuses 80B, 80C, 80D.

Further it is possible to suitably controls the sound system 22 (equalizer, etc.) of each of the EVS generating apparatuses according to the sound environment represented by the sounddetection signal and the image detection signal.

Further the sound emission operation of the EVS generating apparatuses may be stopped when no person is detected within the object space SP based on the image information (image detection signals) from the EVS generating apparatuses 80.

In this embodiment, although the volume level from the microphones and the image information from the cameras are used as the environmental information (feedback information) from the EVS generating apparatuses 80, the invention is not limited thereto but the feedback control may be performed based on other environmental information.

Like the third embodiment, the feedback-controlled environmental sounds of the individual EVS generating apparatuses (satellite devices) maybe generated on the controller 70 side and then transmitted to the individual EVS generating apparatuses (satellite devices).

In a configuration similar to that of the fourth embodiment, in place of performing the feedback control based on the environmental information, the volume, tone quality, etc., for each of the EVS generating apparatuses (satellite devices) may be independently controlled according to feed-forward control based on a manual instruction from the controller.

As an applied example, the controller may analyze and discriminate sex, age, etc. of each of persons within the object space as well as the number of the persons based on the image information fromthe EVS generating apparatuses (satellite devices), and perform other controls according to the discriminated results in addition to the volume level control.

In the aforesaid embodiments, although the environmental sound is generated utilizing the MIDI data, the environmental sound is not necessarily generated utilizing the MIDI data but may be generated using C language program, for example.

Further the communication between the controller and the EVS generating apparatuses (satellite devices) may be performed utilizing Wi-Fi or Bluetooth, for example.

The data of the primary pitch group and the subgroups may be stored in an external memory and installed or red into the EVS generating apparatus or the controller upon starting the generation operation of the environmental sound.

Further, in the environmental sound generating system provided with the plurality of EVS generating apparatuses, the EVS generating apparatuses to be operated for generating the environmental sound may be suitably selected using a selection means such as a switch depending on the environment of the object space.

The invention is not limited to the aforesaid embodiments but various changes and modifications can be made without departing from the spirit and the scope of the invention. Further the functions, numbers, arrangements, etc. of the constituent elements of the aforesaid embodiments are not limited thereto but may be suitably changed or modified within a range capable attaining the invention.

We claims:

1. An environmental sound generating apparatus which generates an environmental sound signal representing an environmental sound that forms sound environment by being emitted, the environmental sound having at least one chain of phonemes constituted of individual phonemes which sound-emission start timings as one of attributes thereof are sequentially shifted, the environmental sound generating apparatus comprising:
attribute setting means which sets at least one of the attributes to a content selected at random from contents within a selection item range that is set over an entirety of the chain of phonemes or at every one of sections constituting the chain of phonemes, the at least one of the attributes including a pitch; and
a sound system which emits the environmental sound according to the environmental sound signal, wherein
a plurality of subgroups are prepared each formed by combining individual plural pitches from pitches constituting a primary pitch group that is a group of phonemes musically treated as consonances if sounded simultaneously, and wherein
the attribute setting means sets one of the plurality of subgroups selected at random to each of the sections of the chain of phonemes, and sets each of the individual phonemes of each section of the chain of phonemes to a pitch selected at random from the plural pitches constituting the selected subgroup to attain hypersonic effects.

2. The environmental sound generating apparatus according to claim 1, wherein the pitches of each of the plurality of subgroup are chords based on the roman numeral analysis of harmony, and the pitches of the primary pitch group include at least two kinds of pitches having different pitch names and at least one kind of pitch which has a different octave but has the same pitch name with respect to at least one of the at least two kinds of pitches.

3. The environmental sound generating apparatus according to claim 2, wherein the environmental sound is constituted of a plurality of the chains of phonemes, and wherein the attribute setting means commonly sets the selected subgroup to all of temporally corresponding sections of the plurality of chains of phonemes, and sets each of the individual phonemes of each of the temporally corresponding sections of the plurality of chains of phonemes to a pitch selected at random from the plural pitches constituting the commonly set subgroup.

4. The environmental sound generating apparatus according to claim 3, wherein the attribute setting means sets a time period from start to termination of sound emission of each of the individual phonemes to constant, and sets sound-emission start timings of the temporally corresponding sections of the plurality of chains of phonemes so as to be shifted sequentially.

5. The environmental sound generating apparatus according to claim 3, wherein the environmental sound attains the hypersonic effects in a frequency range of substantially 50,000 to 80,000 Hz.

6. An environmental sound generating apparatus which generates an environmental sound signal representing an environmental sound that forms sound environment by being emitted, the environmental sound having at least one chain of phonemes constituted of individual phonemes which sound-emission start timings as one of attributes thereof are sequentially shifted, the environmental sound generating apparatus comprising:
attribute setting means which sets at least one of the attributes to a content selected at random from contents within a selection item range that is set over an entirety of the chain of phonemes or at every one of sections constituting the chain of phonemes, the at least one of the attributes including a pitch; and
a memory which stores a plurality of subgroups each prepared by combining individual plural pitches from pitches constituting a primary pitch group that is a group of phonemes musically treated as consonances if sounded simultaneously, wherein
the attribute setting means sets one of the plurality of subgroups selected at random to each of the sections of the chain of phonemes, and sets each of the individual phonemes of each section of the chain of phonemes to a pitch selected at random from the plural pitches constituting the selected subgroup to attain hypersonic effects.

7. An environmental sound generating system, comprising:
a plurality of environmental sound generating apparatuses arranged in an object space dispersively, each of the plurality of environmental sound generating apparatuses generating an environmental sound signal representing an environmental sound that forms sound environment by being emitted, the environmental sound having at least one chain of phonemes constituted of individual phonemes which sound-emission start timings as one of attributes thereof are sequentially shifted, wherein
each of the plurality of environmental sound generating apparatuses comprising:
attribute setting means which sets at least one of the attributes to a content selected at random from contents within a selection item range that is set over an entirety of the chain of phonemes or at every one of sections constituting the chain of phonemes, the at least one of the attributes including a pitch; and
a sound system which emits the environmental sound according to the environmental sound signal, wherein
a plurality of subgroups are prepared each formed by combining individual plural pitches from pitches constituting a primary pitch group that is a group of phonemes musically treated as consonances if sounded simultaneously, and wherein
the attribute setting means sets one of the plurality of subgroups selected at random to each of the sections of the chain of phonemes, and sets each of the individual phonemes of each section of the chain of phonemes to a pitch selected at random from the plural pitches constituting the selected subgroup to attain hypersonic effects.

8. The environmental sound generating system according to claim 7, wherein in each of the plurality of environmental sound generating apparatuses, the pitches of each of the plurality of subgroup are chords based on the roman numeral analysis of harmony, and the pitches of the primary pitch group include at least two kinds of pitches having different pitch names and at least one kind of pitch which has a different octave but has the same pitch name with respect to at least one of the at least two kinds of pitches.

9. The environmental sound generating system according to claim 8, wherein in each of the plurality of environmental sound generating apparatuses, the environmental sound is constituted of a plurality of the chains of phonemes, and wherein the attribute setting means commonly sets the selected subgroup to all of temporally corresponding sections of the plurality of chains of phonemes, and sets each of the individual phonemes of each of the temporally corresponding sections of the plurality of chains of phonemes to a pitch selected at random from the plural pitches constituting the commonly set subgroup.

10. The environmental sound generating system according to claim 9, wherein in each of the plurality of environmental sound generating apparatuses, the attribute setting means sets a time period from start to termination of sound emission of each of the individual phonemes to constant, and sets sound-emission start timings of the temporally corresponding sections of the plurality of chains of phonemes so as to be shifted sequentially.

11. The environmental sound generating system according to claim 9, wherein in each of the plurality of environmental sound generating apparatuses, the environmental sound attains the hypersonic effects in a frequency range of substantially 50,000 to 80,000 Hz.

12. An environmental sound generating system, comprising:
a plurality of environmental sound generating apparatuses arranged in an object space dispersively, each of the plurality of environmental sound generating apparatuses generating an environmental sound signal representing an environmental sound that forms sound environment by being emitted, the environmental sound having at least one chain of phonemes constituted of individual phonemes which sound-emission start timings as one of attributes thereof are sequentially shifted, and
a controller which controls the plurality of environmental sound generating apparatuses, wherein
each of the plurality of environmental sound generating apparatuses comprising:
attribute setting means which sets at least one of the attributes to a content selected at random from contents within a selection item range that is set over an entirety of the chain of phonemes or at every one of sections constituting the chain of phonemes, the at least one of the attributes including a pitch; and
a sound system which emits the environmental sound according to the environmental sound signal, wherein
a plurality of subgroups are prepared each formed by combining individual plural pitches from pitches constituting a primary pitch group that is a group of phonemes musically treated as consonances if sounded simultaneously, and wherein
the attribute setting means sets one of the plurality of subgroups selected at random to each of the sections of the chain of phonemes, and sets each of the individual phonemes of each section of the chain of phonemes to a pitch selected at random from the plural pitches constituting the selected subgroup to attain hypersonic effects.

13. The environmental sound generating system according to claim 12, wherein in each of the plurality of environmental sound generating apparatuses, the pitches of each of the plurality of subgroup are chords based on the roman numeral analysis of harmony, and the pitches of the primary pitch group include at least two kinds of pitches having different pitch names and at least one kind of pitch which has a different octave but has the same pitch name with respect to at least one of the at least two kinds of pitches.

14. The environmental sound generating system according to claim 13, wherein in each of the plurality of environmental sound generating apparatuses, the environmental sound is constituted of a plurality of the chains of phonemes, and wherein the attribute setting means commonly sets the selected subgroup to all of temporally corresponding sections of the plurality of chains of phonemes, and sets each of the individual phonemes of each of the temporally corresponding sections of the plurality of chains of phonemes to a pitch selected at random from the plural pitches constituting the commonly set subgroup.

15. The environmental sound generating system according to claim 14, wherein in each of the plurality of environmental sound generating apparatuses, the attribute setting means sets a time period from start to termination of sound emission of each of the individual phonemes to constant, and sets sound-emission start timings of the temporally corresponding sections of the plurality of chains of phonemes so as to be shifted sequentially.

16. The environmental sound generating system according to claim 14, wherein in each of the plurality of environmental sound generating apparatuses, the environmental sound attains the hypersonic effects in a frequency range of substantially 50,000 to 80,000 Hz.

17. The environmental sound generating system according to claim 12, wherein
each of the plurality of environmental sound generating apparatuses includes environmental information acquisition means which acquires environmental information of an object space corresponding to the environmental sound generating apparatus and transmits acquired environmental information to the controller, and wherein
the controller receives the acquired environmental information from the plurality of environmental sound generating apparatuses, then generates a control signal for controlling the individual environmental sounds emitted from the plurality of environmental sound generating apparatuses based on the received environmental information and transmits the control signal to the plurality of environmental sound generating apparatuses.

18. The environmental sound generating system according to claim 12, wherein
the environmental information acquisition means of each of thepluralityof environmental sound generating apparatuses includes imaging means which obtains an image of the corresponding object space and outputs an image detection signal and sound detection means which detects sound of the corresponding object space and outputs a sound detection signal,
the environmental information acquisition means transmits the image detection signal and the sound detection signal to the controller as the environmental information, and wherein
the controller receives the acquired environmental information from the plurality of environmental sound generating apparatuses, then generates a control signal for controlling at least one of volume level, phase and tone quality of the individual environmental sounds emitted from the plurality of environmental sound generating apparatuses based on the received environmental information and transmits the control signal to the plurality of environmental sound generating apparatuses.

19. A computer program executable by a computer, for use in an environmental sound generating apparatus which generates an environmental sound signal representing an environmental sound that forms sound environment by being emitted, the environmental sound having at least one chain of phonemes constituted of individual phonemes which sound-emission start timings as one of attributes thereof are sequentially shifted, the program comprising the steps of:
setting at least one of the attributes to a content selected at random from contents within a selection item range that is set over an entirety of the chain of phonemes or at every one of sections constituting the chain of phonemes, the at least one of the attributes including a pitch;
preparing a plurality of subgroups each formed by combining individual plural pitches from pitches constituting a primary pitch group that is a group of phonemes musically treated as consonances if sounded simultaneously; and
setting one of the plurality of subgroups selected at random to each of the sections of the chain of phonemes, and setting each of the individual phonemes of each section of the chain of phonemes to a pitch selected at random from the plural pitches constituting the selected subgroup to attain hypersonic effects.

20. A sound environment forming method of forming sound environment by emitting an environmental sound constituted of a plurality of chains of phonemes each of which is constituted of individual phonemes which sound-emission start timings as one of attributes thereof are sequentially shifted, comprising the steps of:
as to at least one of the plurality of chains of phonemes, setting at least one of the attributes to a content selected at random from contents within a selection item range that is set over an entirety of the chain of phonemes or at every one of sections constituting the chain of phonemes, the at least one of the attributes including a pitch;
preparing a plurality of subgroups each formed by combining individual plural pitches from pitches constituting a primary pitch group that is a group of phonemes musically treated as consonances if sounded simultaneously; and
setting one of the plurality of subgroups selected at random to each of the sections of the chain of phonemes, and setting each of the individual phonemes of each section of the chain of phonemes to a pitch selected at random from the plural pitches constituting the selected subgroup to attain hypersonic effects.

21. The sound environment forming method according to claim 20, wherein
the pitches of each of the plurality of subgroup are chords based on the roman numeral analysis of harmony, and the pitches of the primary pitch group include at least two kinds of pitches having different pitch names and at least one kind of pitch which has a different octave but has the same pitch name with respect to at least one of the at least two kinds of pitches.

22. The sound environment forming method according to claim 21, wherein
the environmental sound is constituted of a plurality of the chains of phonemes, and wherein
the selected subgroup are commonly set to all of temporally corresponding sections of the plurality of chains of phonemes, and each of the individual phonemes of each of the temporally corresponding sections of the plurality of chains of phonemes is set to a pitch selected at random from the plural pitches constituting the commonly set subgroup.

23. The sound environment forming method according to claim 22, wherein a time period from start to termination of sound emission of each of the individual phonemes is to constant, and sound-emission start timings of the temporally corresponding sections of the plurality of chains of phonemes are set so as to be shifted sequentially.

24. The sound environment forming method according to claim 22, wherein the environmental sound attains the hypersonic effects in a frequency range of substantially 50,000 to 80,000 Hz.

25. A storage medium storing program executed by a computer, for use in an environmental sound generating apparatus which generates an environmental sound signal representing an environmental sound that forms sound environment by being emitted, the environmental sound having at least one chain of phonemes constituted of individual phonemes which sound-emission start timings as one of attributes thereof are sequentially shifted, the program comprising the steps of:
setting at least one of the attributes to a content selected at random from contents within a selection item range that is set over an entirety of the chain of phonemes or at every one of sections constituting the chain of phonemes, the at least one of the attributes including a pitch;
preparing a plurality of subgroups each formed by combining individual plural pitches from pitches constituting a primary pitch group that is a group of phonemes musically treated as consonances if sounded simultaneously; and
setting one of the plurality of subgroups selected at random to each of the sections of the chain of phonemes, and setting each of the individual phonemes of each section of the chain of phonemes to a pitch selected at random from the plural pitches constituting the selected subgroup to attain hypersonic effects.
